(19) United States
(12) Patent Application Publication
(10) Pub. No.: US 2024/0049097 A1
(43) Pub. Date: Feb. 8, 2024

(54) METHODS, APPARATUSES, AND COMPUTER PROGRAM PRODUCTS FOR FAST CELL SELECTION USING CONDITIONAL HANDOVER AND INTERCELL BEAM MANAGEMENT REPORTING

(71) Applicant: Nokia Technologies Oy, Espoo (FI)

(72) Inventors: Ahmad AWADA, Munich (DE); Timo KOSKELA, Oulu (FI); Anup TALUKDAR, Naperville, IL (US); Tero HENTTONEN, Espoo (FI); Ingo VIERING, Munich (DE)

(21) Appl. No.: 18/258,996

(22) PCT Filed: Jan. 8, 2021
(86) PCT No.: PCT/US2021/012635

§ 371 Date: Jun. 22, 2023

(51) Int. Cl. H04W 36/36; H04W 36/00

(52) U.S. Cl. CPC H04W 36/362; H04W 36/00837; H04W 36/00725

(57) ABSTRACT

Methods, apparatuses, and computer program products are described that support operational mode configurations for switching between serving cells. A serving cell may configure a plurality of cells to support the operational mode configuration. Each cell of the plurality of cells and an associated user equipment may store the operational mode configurations associated with the plurality of cells to improve additional switching between serving cells. A user equipment may provide intracell or intercell beam management reporting associated with the plurality of cells to assist a determination for switching between serving cells. Timing advance information may be stored to support switching back to a serving cell. A serving cell may cause switching to another serving cell for a user equipment.

### TECHNOLOGICAL FIELD

An example embodiment relates generally to cell selection that utilizes conditional handover and beam management reporting via a communication infrastructure.

### BACKGROUND

The 3rd Generation Partnership Project (3GPP) is a standards organization which develops protocols for mobile telephony and is known for the development and maintenance of various standards including second generation (2G), third generation (3G), fourth generation (4G), Long Term Evolution (LTE), and fifth generation (5G) standards. The 5G network has been designed as a Service Based Architecture (SBA) or, in other words, a system architecture in which the system functionality is achieved by a set of network functions providing services to other authorized network functions to access their services.

The 5G network may comprise a plurality of base stations (e.g., Next generation NodeB (gNB), etc.) that serve multiple cells across a particular area. As a User Equipment (UE) moves through the particular area cell changes, known as handovers in the connected mode, occur to maintain connectivity between the UE and the serving Radio Access Network (RAN). Moreover, cells transmit and receive data via multiple beams Handover procedures may be triggered as a result of rotation of the UE or as a result of obstructions between the UE and base stations (e.g., a wall, etc.).

Conditional Handover (CHO) allows a source cell to prepare a UE with multiple target cells for future handover procedures. The preparation for the CHO occurs during good radio conditions between the source cell and the UE before the handover is required to maintain communication. The UE determines that a CHO is necessary based on detection of a configured condition. Upon detection of conditions necessitating the CHO, the UE executes the prepared CHO to one of the target cells. The CHO is more likely to happen because of preparation during good radio conditions and the handover between cells is triggered during poorer radio conditions.

### BRIEF SUMMARY

Methods, apparatuses, and computer program products are disclosed which facilitate the mobility of a UE via the architecture of a communications network that provides for data is exchanged via beams. The present disclosure provides for improved operational modes associated with the UE for cell selection and handover. Example embodiments of the present disclosure provide for a Fast Cell Selection (FCS) mode to more effectively and more efficiently handover a UE from a first serving cell to a second serving cell. The FCS mode provides for selection and handover of a UE between cells facilitated by an FCS Conditional Handover (FCSCHO) configuration. The UE may comprise a first FCSCHO configuration for the serving cell and at least a second FCSCHO configuration for at least one neighboring cell. The UE may be configured to report Layer 1 (L1) beam measurements for one or more cells associated with an FCSCHO configuration.

The UE may receive lower layer indications from the serving cell instructing the UE to change from the serving cell to another cell (e.g., based on the L1 beam measurements, etc.). Upon receipt of the switching instructions from the serving cell, the UE executes a cell change (e.g. a CHO or the like) to another cell associated with an FCSCHO configuration (e.g., the at least one neighboring cell associated with the second FCSCHO configuration. Moreover, upon completion of the switching procedures the UE may store (e.g., keep in memory, etc.) all FCSCHO configurations including, without limitation, the first FCSCHO configuration of the first serving cell. The network, or an entity thereof (e.g., network function, RAN, base station, cell, etc.), may store the UE context for all of the prepared FCSCHO configurations.

The UE may utilize one or more of the FCSCHO configurations for further execution of cell switching procedures towards the first serving cell and/or one or more other neighbouring cells in the area. For example, if the UE is traversing a first direction of a two-way pathway within an area the UE may utilize a stored FCSCHO configuration to more quickly and easily switch back to the first serving cell upon traversing a second (e.g., return, etc.) direction of the two-way pathway. It should be appreciated, in light of the present disclosure, that the UE is connected to a single cell at a given time but that the network can configure the handover procedures for each cell at a single time thereby allowing switching between the cells at a faster rate and with less demand on lower layer resources, particularly when compared with conventional procedures (e.g., Radio Resource Control (RRC) procedures, etc.).

It should be appreciated, in light of the present disclosure, that example embodiments utilizing at least an FCSCHO configuration overcome multiple problems associated with conventional handover systems. For example, any conventional CHO preparation information for switching from the source cell to the selected target cell is deleted by the UE upon successful completion of the prepared CHO. In conventional systems the network also does not store the prepared UE context upon successful completion of the prepared CHO because the previously prepared CHO is no longer valid at the new source cell (i.e., the previously selected target cell). Therefore, conventional CHO implementations require that a new preparation for a new CHO must occur again during good radio conditions between the new source cell and the UE to facilitate any additional future CHO. Example embodiments of the present disclosure overcome such limitations by at least storing all previous prepared FCSCHO configurations for improved handover speeds when handover is required back to previously prepared cells. FCSCHO configurations and techniques of the present disclosure may be configured for use with a plurality of handover procedures including without limitation those procedures associated with one or more of conditional handovers, return handovers, concatenated conditional handovers, handovers without conditions, coordinated multi-point (CoMP) processes, dynamic point selection processes, beam management reporting processes, beam switching processes, or the like.

According to an aspect of the present disclosure, there is provided a method that comprises receiving, from a first serving cell, one or more operational mode configurations for a plurality of cells. The method may further comprise determining first beam management information for the plurality of cells. The method may further comprise causing transmission, to the first serving cell, of a first beam management report comprising the first beam management information for the plurality of cells. The method may further comprise receiving, from the first serving cell, a switch indication comprising instructions to switch to a target beam of a target cell. The method may further comprise causing storage of the one or more operational mode configurations for the plurality of cells. The method may further comprise switching from the first serving cell to the target beam of the target cell, wherein the target cell becomes a second serving cell.

In some embodiments, the method may further comprise causing storage of timing advance information for the first serving cell. In some embodiments, the method may further comprise determining second beam management information for the plurality of cells. In some embodiments, the method may further comprise causing transmission, to the second serving cell, of a second beam management report comprising the second beam management information for the plurality of cells. In some embodiments, the method may further comprise retrieving the one or more operational mode configurations and the timing advance information. In some embodiments, the method may further comprise switching, based on at least the timing advance information, from the second serving cell to the first serving cell.

In some embodiments of the method, switching from the first serving cell to the second serving cell comprises a random access channel-less handover, and wherein the stored timing advance information is used for switching from the second serving cell to the first serving cell. In some embodiments of the method, the one or more operational mode configurations comprises one or more of a fast cell selection conditional handover configuration for each cell of the plurality of cells, the first beam management information, or the second beam management information. In some embodiments of the method, one or more of the first beam management information or the second beam management information are generated based on reference signals transmitted by the plurality of cells, wherein the reference signals comprise synchronization signal block resource mapping. In some embodiments of the method, one or more of the first beam management report or the second beam management report comprise one or more of intracell or intercell beam management reporting associated with one or more cells of the plurality of cells. In some embodiments of the method, one or more of a user equipment, a network, a radio access network, a base station, or a cell store one or more of the one or more operational mode configurations, the first beam management information, the second beam management information, or the timing advance information for at least a respective cell of the plurality of cells. In some embodiments of the method, the plurality of cells comprises one or more of a neighboring cell of the first serving cell, a neighboring cell of the second serving cell, the first serving cell, or the second serving cell. In some embodiments of the method, the switch indication comprises a medium access control element. In some embodiments of the method, the switching to the target beam of the target cell is dynamically caused by a trigger condition configured by the first serving cell or the second serving cell. In some embodiments of the method, the target cell is associated with a plurality of target beams.

According to an aspect of the present disclosure, there is provided an apparatus that comprises at least one processor and at least one memory with the at least one memory including computer program code, that is configured to, with the at least one processor, cause the apparatus at least to receive, from a first serving cell, one or more operational mode configurations for a plurality of cells. The apparatus may be further caused to at least determine first beam management information for the plurality of cells. The apparatus may be further caused to at least cause transmission, to the first serving cell, of a first beam management report comprising the first beam management information for the plurality of cells. The apparatus may be further caused to at least receive, from the first serving cell, a switch indication comprising instructions to switch to a target beam of a target cell. The apparatus may be further caused to at least cause storage of the one or more operational mode configurations for the plurality of cells. The apparatus may be further caused to at least switch from the first serving cell to the target beam of the target cell, wherein the target cell becomes a second serving cell.

In some embodiments, the apparatus may be further caused to at least cause storage of timing advance information for the first serving cell. In some embodiments, the apparatus may be further caused to at least determine second beam management information for the plurality of cells. In some embodiments, the apparatus may be further caused to at least cause transmission, to the second serving cell, of a second beam management report comprising the second beam management information for the plurality of cells. In some embodiments, the apparatus may be further caused to at least retrieve the one or more operational mode configurations and the timing advance information. In some embodiments, the apparatus may be further caused to at least switch, based on at least the timing advance information, from the second serving cell to the first serving cell.

In some embodiments of the apparatus, switching from the first serving cell to the second serving cell comprises a random access channel-less handover, and wherein the stored timing advance information is used for switching from the second serving cell to the first serving cell. In some embodiments of the apparatus, the one or more operational mode configurations comprises one or more of a fast cell selection conditional handover configuration for each cell of the plurality of cells, the first beam management information, or the second beam management information. In some embodiments of the apparatus, one or more of the first beam management information or the second beam management information are generated based on reference signals transmitted by the plurality of cells, wherein the reference signals comprise synchronization signal block resource mapping. In some embodiments of the apparatus, one or more of the first beam management report or the second beam management report comprise one or more of intracell or intercell beam management reporting associated with one or more cells of the plurality of cells. In some embodiments of the apparatus, one or more of a user equipment, a network, a radio access network, a base station, or a cell store one or more of the one or more operational mode configurations, the first beam management information, the second beam management information, or the timing advance information for at least a respective cell of the plurality of cells. In some embodiments of the apparatus, the plurality of cells comprises one or more of a neighboring cell of the first serving cell, a neighboring cell of the second serving cell, the first serving cell, or the second serving cell. In some embodiments of the apparatus, the switch indication comprises a medium access control element. In some embodiments of the apparatus, the switching to the target beam of the target cell is dynamically caused by a trigger condition configured by the first serving cell or the second serving cell. In some embodiments of the apparatus, the target cell is associated with a plurality of target beams.

According to an aspect of the present disclosure, there is provided a computer program product that comprises at least a non-transitory computer readable storage medium having program code portions stored thereon with the program code portions being configured, upon execution, by at least a processor, to receive, from a first serving cell, one or more operational mode configurations for a plurality of cells. The computer program product may be further configured, upon execution, by at least the processor, to at least determine first beam management information for the plurality of cells. The computer program product may be further configured, upon execution, by at least the processor, to at least cause transmission, to the first serving cell, of a first beam management report comprising the first beam management information for the plurality of cells. The computer program product may be further configured, upon execution, by at least the processor, to at least receive, from the first serving cell, a switch indication comprising instructions to switch to a target beam of a target cell. The computer program product may be further configured, upon execution, by at least the processor, to at least cause storage of the one or more operational mode configurations for the plurality of cells. The computer program product may be further configured, upon execution, by at least the processor, to at least switch from the first serving cell to the target beam of the target cell, wherein the target cell becomes a second serving cell.

In some embodiments, the computer program product may be further configured, upon execution, by at least the processor, to at least cause storage of timing advance information for the first serving cell. In some embodiments, the computer program product may be further configured, upon execution, by at least the processor, to at least determine second beam management information for the plurality of cells. In some embodiments, the computer program product may be further configured, upon execution, by at least the processor, to at least cause transmission, to the second serving cell, of a second beam management report comprising the second beam management information for the plurality of cells. In some embodiments, the computer program product may be further configured, upon execution, by at least the processor, to at least retrieve the one or more operational mode configurations and the timing advance information. In some embodiments, the computer program product may be further configured, upon execution, by at least the processor, to at least switch, based on at least the timing advance information, from the second serving cell to the first serving cell.

In some embodiments of the computer program product, switching from the first serving cell to the second serving cell comprises a random access channel-less handover, and wherein the stored timing advance information is used for switching from the second serving cell to the first serving cell. In some embodiments of the computer program product, the one or more operational mode configurations comprises one or more of a fast cell selection conditional handover configuration for each cell of the plurality of cells, the first beam management information, or the second beam management information. In some embodiments of the computer program product, one or more of the first beam management information or the second beam management information are generated based on reference signals transmitted by the plurality of cells, wherein the reference signals comprise synchronization signal block resource mapping. In some embodiments of the computer program product, one or more of the first beam management report or the second beam management report comprise one or more of intracell or intercell beam management reporting associated with one or more cells of the plurality of cells. In some embodiments of the computer program product, one or more of a user equipment, a network, a radio access network, a base station, or a cell store one or more of the one or more operational mode configurations, the first beam management information, the second beam management information, or the timing advance information for at least a respective cell of the plurality of cells. In some embodiments of the computer program product, the plurality of cells comprises one or more of a neighboring cell of the first serving cell, a neighboring cell of the second serving cell, the first serving cell, or the second serving cell. In some embodiments of the computer program product, the switch indication comprises a medium access control element. In some embodiments of the computer program product, the switching to the target beam of the target cell is dynamically caused by a trigger condition configured by the first serving cell or the second serving cell. In some embodiments of the computer program product, the target cell is associated with a plurality of target beams.

According to an aspect of the present disclosure, there is provided an apparatus that comprises means for receiving, from a first serving cell, one or more operational mode configurations for a plurality of cells. The apparatus may further comprise means for determining first beam management information for the plurality of cells. The apparatus may further comprise means for causing transmission, to the first serving cell, of a first beam management report comprising the first beam management information for the plurality of cells. The apparatus may further comprise means for receiving, from the first serving cell, a switch indication comprising instructions to switch to a target beam of a target cell. The apparatus may further comprise means for causing storage of the one or more operational mode configurations for the plurality of cells. The apparatus may further comprise means for switching from the first serving cell to the target beam of the target cell, wherein the target cell becomes a second serving cell.

In some embodiments, the apparatus may further comprise means for causing storage of timing advance information for the first serving cell. In some embodiments, the apparatus may further comprise means for determining second beam management information for the plurality of cells. In some embodiments, the apparatus may further comprise means for causing transmission, to the second serving cell, of a second beam management report comprising the second beam management information for the plurality of cells. In some embodiments, the apparatus may further comprise means for retrieving the one or more operational mode configurations and the timing advance information. In some embodiments, the apparatus may further comprise means for switching, based on at least the timing advance information, from the second serving cell to the first serving cell.

In some embodiments of the apparatus, switching from the first serving cell to the second serving cell comprises a random access channel-less handover, and wherein the stored timing advance information is used for switching from the second serving cell to the first serving cell. In some embodiments of the apparatus, the one or more operational mode configurations comprises one or more of a fast cell selection conditional handover configuration for each cell of the plurality of cells, the first beam management information, or the second beam management information. In some embodiments of the apparatus, one or more of the first beam management information or the second beam management information are generated based on reference signals transmitted by the plurality of cells, wherein the reference signals comprise synchronization signal block resource mapping. In some embodiments of the apparatus, one or more of the first beam management report or the second beam management report comprise one or more of intracell or intercell beam management reporting associated with one or more cells of the plurality of cells. In some embodiments of the apparatus, one or more of a user equipment, a network, a radio access network, a base station, or a cell store one or more of the one or more operational mode configurations, the first beam management information, the second beam management information, or the timing advance information for at least a respective cell of the plurality of cells. In some embodiments of the apparatus, the plurality of cells comprises one or more of a neighboring cell of the first serving cell, a neighboring cell of the second serving cell, the first serving cell, or the second serving cell. In some embodiments of the apparatus, the switch indication comprises a medium access control element. In some embodiments of the apparatus, the switching to the target beam of the target cell is dynamically caused by a trigger condition configured by the first serving cell or the second serving cell. In some embodiments of the apparatus, the target cell is associated with a plurality of target beams.

According to an aspect of the present disclosure, there is provided a method that comprises determining to use an operational mode for handovers. The method may further comprise causing transmission, to a user equipment, of one or more operational mode configurations for a plurality of cells. The method may further comprise receiving, from the user equipment, a beam management report comprising beam management information for the plurality of cells. The method may further comprise determining, based on at least the beam management report, to instruct the user equipment to switch to a second serving cell from a first serving cell. The method may further comprise causing transmission, to the user equipment, of a switch indication comprising instructions to switch to a target beam of a target cell, wherein the target cell becomes the second serving cell.

In some embodiments, the method may further comprise causing transmission, to the target cell, of a handover request, wherein the handover request comprises instructions to configure the target cell for a fast cell selection conditional handover. In some embodiments, the method may further comprise receiving, from the target cell, a handover request acknowledgment. In some embodiments, the method may further comprise causing storage of the one or more operational mode configurations for the plurality of cells. In some embodiments, the method may further comprise causing transmission, to the target cell, of the beam management report comprising the beam management information for the plurality of cells. In some embodiments of the method, the handover request comprises transmission configuration indicator states.

In some embodiments, the method may further comprise causing transmission, to the user equipment, of a trigger condition causing the user equipment to dynamically switch to the target cell.

In some embodiments, the method may further comprise causing transmission, to the target cell, of the one or more operational mode configurations for the plurality of cells.

In some embodiments of the method, the determining to use the operational mode for handovers is based on historical data, and wherein the historical data comprises one or more of a number of handovers, a time period, a threshold value, metadata, a communication log, or network entity behavior. In some embodiments of the method, the historical data is processed via a machine learning algorithm or a self-organizing method. In some embodiments of the method, the target cell is one of a plurality of target cells. In some embodiments of the method, the operational mode for handovers comprises a fast cell selection operational mode. In some embodiments of the method, the plurality of cells comprises one or more of a neighboring cell of the first serving cell, a neighboring cell of the second serving cell, the first serving cell, or the second serving cell. In some embodiments of the method, the beam management report comprises one or more of intracell or intercell beam management reporting associated with the plurality of cells. In some embodiments of the method, the switch indication comprises one or more of a medium access control element. In some embodiments of the method, one or more of the user equipment, a network, a radio access network, a base station, or a cell store one or more of the one or more operational mode configurations, the beam management information, or a timing advance information associated for at least a respective cell of the plurality of cells. In some embodiments of the method, the one or more operational mode configurations comprises one or more of a fast cell selection conditional handover configuration for each cell of the plurality of cells, a first beam management information, or a second beam management information.

According to an aspect of the present disclosure, there is provided an apparatus that comprises at least one processor and at least one memory with the at least one memory including computer program code, that is configured to, with the at least one processor, cause the apparatus at least to determine to use an operational mode for handovers. The apparatus may be further caused to at least cause transmission, to a user equipment, of one or more operational mode configurations for a plurality of cells. The apparatus may be further caused to at least receive, from the user equipment, a beam management report comprising beam management information for the plurality of cells. The apparatus may be further caused to at least determine, based on at least the beam management report, to instruct the user equipment to switch to a second serving cell from a first serving cell. The apparatus may be further caused to at least cause transmission, to the user equipment, of a switch indication comprising instructions to switch to a target beam of a target cell, wherein the target cell becomes the second serving cell.

In some embodiments, the apparatus may be further caused to at least cause transmission, to the target cell, of a handover request, wherein the handover request comprises instructions to configure the target cell for a fast cell selection conditional handover. In some embodiments, the apparatus may be further caused to at least receive, from the target cell, a handover request acknowledgment. In some embodiments, the apparatus may be further caused to at least cause storage of the one or more operational mode configurations for the plurality of cells. In some embodiments, the apparatus may be further caused to at least cause transmission, to the target cell, of the beam management report comprising the beam management information for the plurality of cells. In some embodiments of the apparatus, the handover request comprises transmission configuration indicator states.

In some embodiments, the apparatus may be further caused to at least cause transmission, to the user equipment, of a trigger condition causing the user equipment to dynamically switch to the target cell.

In some embodiments, the apparatus may be further caused to at least cause transmission, to the target cell, of the one or more operational mode configurations for the plurality of cells.

In some embodiments of the apparatus, the determining to use the operational mode for handovers is based on historical data, and wherein the historical data comprises one or more of a number of handovers, a time period, a threshold value, metadata, a communication log, or network entity behavior. In some embodiments of the apparatus, the historical data is processed via a machine learning algorithm or a self-organizing method. In some embodiments of the apparatus, the target cell is one of a plurality of target cells. In some embodiments of the apparatus, the operational mode for handovers comprises a fast cell selection operational mode. In some embodiments of the apparatus, the plurality of cells comprises one or more of a neighboring cell of the first serving cell, a neighboring cell of the second serving cell, the first serving cell, or the second serving cell. In some embodiments of the apparatus, the beam management report comprises one or more of intracell or intercell beam management reporting associated with the plurality of cells. In some embodiments of the apparatus, the switch indication comprises one or more of a medium access control element. In some embodiments of the apparatus, one or more of the user equipment, a network, a radio access network, a base station, or a cell store one or more of the one or more operational mode configurations, the beam management information, or a timing advance information associated for at least a respective cell of the plurality of cells. In some embodiments of the apparatus, the one or more operational mode configurations comprises one or more of a fast cell selection conditional handover configuration for each cell of the plurality of cells, a first beam management information, or a second beam management information.

According to an aspect of the present disclosure, there is provided a computer program product that comprises at least a non-transitory computer readable storage medium having program code portions stored thereon with the program code portions being configured, upon execution, by at least a processor, to determine to use an operational mode for handovers. The computer program product may be further configured, upon execution, by at least the processor, to at least cause transmission, to a user equipment, of one or more operational mode configurations for a plurality of cells. The computer program product may be further configured, upon execution, by at least the processor, to at least receive, from the user equipment, a beam management report comprising beam management information for the plurality of cells. The computer program product may be further configured, upon execution, by at least the processor, to at least determine, based on at least the beam management report, to instruct the user equipment to switch to a second serving cell from a first serving cell. The computer program product may be further configured, upon execution, by at least the processor, to at least cause transmission, to the user equipment, of a switch indication comprising instructions to switch to a target beam of a target cell, wherein the target cell becomes the second serving cell.

In some embodiments, the computer program product may be further configured, upon execution, by at least the processor, to at least cause transmission, to the target cell, of a handover request, wherein the handover request comprises instructions to configure the target cell for a fast cell selection conditional handover. In some embodiments, the computer program product may be further configured, upon execution, by at least the processor, to at least receive, from the target cell, a handover request acknowledgment. In some embodiments, the computer program product may be further configured, upon execution, by at least the processor, to at least cause storage of the one or more operational mode configurations for the plurality of cells. In some embodiments, the computer program product may be further configured, upon execution, by at least the processor, to at least cause transmission, to the target cell, of the beam management report comprising the beam management information for the plurality of cells. In some embodiments of the computer program product, the handover request comprises transmission configuration indicator states.

In some embodiments, the computer program product may be further configured, upon execution, by at least the processor, to at least cause transmission, to the user equipment, of a trigger condition causing the user equipment to dynamically switch to the target cell.

In some embodiments, the computer program product may be further configured, upon execution, by at least the processor, to at least cause transmission, to the target cell, of the one or more operational mode configurations for the plurality of cells.

In some embodiments of the computer program product, the determining to use the operational mode for handovers is based on historical data, and wherein the historical data comprises one or more of a number of handovers, a time period, a threshold value, metadata, a communication log, or network entity behavior. In some embodiments of the computer program product, the historical data is processed via a machine learning algorithm or a self-organizing method. In some embodiments of the computer program product, the target cell is one of a plurality of target cells. In some embodiments of the computer program product, the operational mode for handovers comprises a fast cell selection operational mode. In some embodiments of the computer program product, the plurality of cells comprises one or more of a neighboring cell of the first serving cell, a neighboring cell of the second serving cell, the first serving cell, or the second serving cell. In some embodiments of the computer program product, the beam management report comprises one or more of intracell or intercell beam management reporting associated with the plurality of cells. In some embodiments of the computer program product, the switch indication comprises one or more of a medium access control element. In some embodiments of the computer program product, one or more of the user equipment, a network, a radio access network, a base station, or a cell store one or more of the one or more operational mode configurations, the beam management information, or a timing advance information associated for at least a respective cell of the plurality of cells. In some embodiments of the computer program product, the one or more operational mode configurations comprises one or more of a fast cell selection conditional handover configuration for each cell of the plurality of cells, a first beam management information, or a second beam management information.

According to an aspect of the present disclosure, there is provided an apparatus that comprises means for determining to use an operational mode for handovers. The apparatus may further comprise means for causing transmission, to a user equipment, of one or more operational mode configurations for a plurality of cells. The apparatus may further comprise means for receiving, from the user equipment, a beam management report comprising beam management information for the plurality of cells. The apparatus may further comprise means for determining, based on at least the beam management report, to instruct the user equipment to switch to a second serving cell from a first serving cell. The apparatus may further comprise means for causing transmission, to the user equipment, of a switch indication comprising instructions to switch to a target beam of a target cell, wherein the target cell becomes the second serving cell.

In some embodiments, the apparatus may further comprise means for causing transmission, to the target cell, of a handover request, wherein the handover request comprises instructions to configure the target cell for a fast cell selection conditional handover. In some embodiments, the apparatus may further comprise means for receiving, from the target cell, a handover request acknowledgment. In some embodiments, the apparatus may further comprise means for causing storage of the one or more operational mode configurations for the plurality of cells. In some embodiments, the apparatus may further comprise means for causing transmission, to the target cell, of the beam management report comprising the beam management information for the plurality of cells. In some embodiments of the apparatus, the handover request comprises transmission configuration indicator states.

In some embodiments, the apparatus may further comprise means for causing transmission, to the user equipment, of a trigger condition causing the user equipment to dynamically switch to the target cell.

In some embodiments, the apparatus may further comprise means for causing transmission, to the target cell, of the one or more operational mode configurations for the plurality of cells.

In some embodiments of the apparatus, the determining to use the operational mode for handovers is based on historical data, and wherein the historical data comprises one or more of a number of handovers, a time period, a threshold value, metadata, a communication log, or network entity behavior. In some embodiments of the apparatus, the historical data is processed via a machine learning algorithm or a self-organizing method. In some embodiments of the apparatus, the target cell is one of a plurality of target cells. In some embodiments of the apparatus, the operational mode for handovers comprises a fast cell selection operational mode. In some embodiments of the apparatus, the plurality of cells comprises one or more of a neighboring cell of the first serving cell, a neighboring cell of the second serving cell, the first serving cell, or the second serving cell. In some embodiments of the apparatus, the beam management report comprises one or more of intracell or intercell beam management reporting associated with the plurality of cells. In some embodiments of the apparatus, the switch indication comprises one or more of a medium access control element. In some embodiments of the apparatus, one or more of the user equipment, a network, a radio access network, a base station, or a cell store one or more of the one or more operational mode configurations, the beam management information, or a timing advance information associated for at least a respective cell of the plurality of cells. In some embodiments of the apparatus, the one or more operational mode configurations comprises one or more of a fast cell selection conditional handover configuration for each cell of the plurality of cells, a first beam management information, or a second beam management information.

Various other aspects are also described in the following detailed description and in the attached claims.

### BRIEF DESCRIPTION OF THE DRAWINGS

Having thus described embodiments of the disclosure in general terms, reference will now be made to the accompanying drawings, which are not necessarily drawn to scale, and wherein:

FIG. 1 illustrates an example architecture for a communications network, according to some embodiments;

FIG. 2 illustrates an example architecture for a communications network, according to some embodiments;

FIG. 3 illustrates an example architecture for a communications network, according to some embodiments;

FIG. 4 illustrates an example computing device for communicating over communication networks with other network entities, according to some embodiments;

FIG. 5 illustrates an example architecture for a communications network comprising base stations, cells, and beams, according to some embodiments;

FIG. 6 is a flow diagram illustrating the signaling between communication devices via a network infrastructure, according to some embodiments;

FIG. 7 is a flowchart illustrating the operations performed, such as by a communication device or other client device, in accordance with some example embodiments;

FIG. 8 is a flowchart illustrating the operations performed, such as by a communication device or other client device, in accordance with some example embodiments; and

FIG. 9 is a flowchart illustrating the operations performed, such as by a communication device or other client device, in accordance with some example embodiments.

### DETAILED DESCRIPTION

Some embodiments of the present invention will now be described more fully hereinafter with reference to the accompanying drawings, in which some, but not all, embodiments of the invention are shown. Indeed, various embodiments of the invention can be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms can be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Additionally, as used herein, the terms “node,” “entity,” “intermediary,” “intermediate entity,” “go-between,” and similar terms can be used interchangeably to refer to computers connected via, or programs running on, a network or plurality of networks capable of data creation, modification, deletion, transmission, receipt, and/or storage in accordance with embodiments of the present invention. Thus, use of any such terms should not be taken to limit the spirit and scope of embodiments of the present invention.

Additionally, as used herein, the terms “user equipment,” “user device,” “device,” “apparatus,” “mobile device,” “personal computer,” “laptop computer,” “laptop,” “desktop computer,” “desktop,” “mobile phone,” “tablet,” “smartphone,” “smart device,” “cellphone,” “computing device,” “communication device,” “user communication device,” “terminal,” and similar terms can be used interchangeably to refer to an apparatus, such as may be embodied by a computing device, configured to access a network or plurality of networks for at least the purpose of wired and/or wireless transmission of communication signals in accordance with certain embodiments of the present disclosure. Thus, use of any such terms should not be taken to limit the spirit and scope of embodiments of the present disclosure.

Additionally, as used herein, the terms “network slice,” “specific slice,” “slice,” “network portion,” and similar terms can be used interchangeably to refer to an end to end logical communication network, or portion thereof, within a PLMN, SNPN, PNI-NPN, or another network.

As defined herein, a “computer-readable storage medium,” which refers to a non-transitory physical storage medium (e.g., volatile or non-volatile memory device), can be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc (BD), the like, or combinations thereof), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

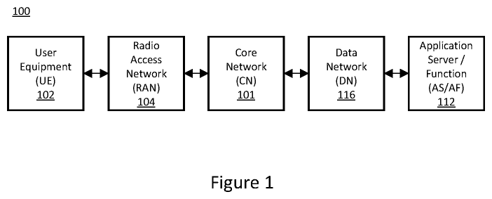

In the following, certain embodiments are explained with reference to communication devices capable of communication via a wired and/or wireless network and communication systems serving such communication devices. Before explaining in detail these example embodiments, certain general principles of a wired and/or wireless communication system, access systems thereof, and communication devices are briefly explained with reference to FIGS. 1-3 to assist in understanding the technology underlying the described examples.

According to some embodiments, a communication device or terminal can be provided for wireless access via cells, base stations, access points, the like (e.g., wireless transmitter and/or receiver nodes providing access points for a radio access communication system and/or other forms of wired and/or wireless networks), or combinations thereof. Such wired and/or wireless networks include, but are not limited to, networks configured to conform to 2G, 3G, 4G, LTE, 5G, and/or any other similar or yet to be developed future communication network standards. The present disclosure contemplates that any methods, apparatuses, computer program codes, and any portions or combination thereof can also be implemented with yet undeveloped communication networks and associated standards as would be developed in the future and understood by one skilled in the art in light of the present disclosure.

Access points and hence communications there through are typically controlled by at least one appropriate control apparatus so as to enable operation thereof and management of mobile communication devices in communication therewith. In some embodiments, a control apparatus for a node can be integrated with, coupled to, and/or otherwise provided for controlling the access points. In some embodiments, the control apparatus can be arranged to allow communications between a user equipment and a core network or a network entity of the core network. For this purpose, the control apparatus can comprise at least one memory, at least one data processing unit such as a processor or the like, and an input/output interface (e.g., global positioning system receiver/transmitter, keyboard, mouse, touchpad, display, universal serial bus (USB), Bluetooth, ethernet, wired/wireless connections, the like, or combinations thereof). Via the interface, the control apparatus can be coupled to relevant other components of the access point. The control apparatus can be configured to execute an appropriate software code to provide the control functions. It shall be appreciated that similar components can be provided in a control apparatus provided elsewhere in the network system, for example in a core network entity. The control apparatus can be interconnected with other control entities. The control apparatus and functions can be distributed between several control units. In some embodiments, each base station can comprise a control apparatus. In alternative embodiments, two or more base stations can share a control apparatus.

Access points and associated controllers can communicate with each other via a fixed line connection and/or via a radio interface. The logical connection between the base station nodes can be provided for example by an X2, an S1, a similar interface, or combinations thereof. This interface can be used for example for coordination of operation of the stations and performing reselection or handover operations. The logical communication connection between the initial communication node and the final communication node of the network can comprise a plurality of intermediary nodes. Additionally, any of the nodes can be added to and removed from the logical communication connection as required to establish and maintain a network function communication.

The communication device or user equipment can comprise any suitable device capable of at least receiving a communication signal comprising data. The communication signal can be transmitted via a wired connection, a wireless connection, or combinations thereof. For example, the device can be a handheld data processing device equipped with radio receiver, data processing and user interface apparatus. Non-limiting examples include a mobile station (MS) such as a mobile phone or what is known as a ‘smart phone,’ a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, earpieces with wireless connectivity, jewelry and so on, Universal Serial Bus (USB) sticks with wireless capabilities, modem data cards, machine type devices or any combinations of these or the like.

In some embodiments, a communication device, e.g., configured for communication with the wireless network or a core network entity, can be exemplified by a handheld or otherwise mobile communication device or user equipment. A mobile communication device can be provided with wireless communication capabilities and appropriate electronic control apparatus for enabling operation thereof. Thus, the communication device can be provided with at least one data processing entity, for example a central processing unit and/or a core processor, at least one memory and other possible components such as additional processors and memories for use in software and hardware aided execution of tasks it is designed to perform. The data processing, storage, and other relevant control apparatus can be provided on an appropriate circuit board and/or in chipsets. Data processing and memory functions provided by the control apparatus of the communication device are configured to cause control and signaling operations in accordance with certain embodiments as described later in this description. A user can control the operation of the communication device by means of a suitable user interface such as touch sensitive display screen or pad and/or a keypad, one of more actuator buttons, voice commands, combinations of these, or the like. A speaker and a microphone are also typically provided. Furthermore, a mobile communication device can comprise appropriate connectors (either wired or wireless) to other devices and/or for connecting external accessories, for example hands-free equipment, thereto.

In some embodiments, a communication device can communicate wirelessly via one or more appropriate apparatuses for receiving and transmitting signals (e.g., global positioning system receiver/transmitter, remote touchpad interface with remote display, Wi-Fi interface, etc.). In some embodiments, a radio unit can be connected to the control apparatus of the device. The radio unit can comprise a radio part and associated antenna arrangement. The antenna arrangement can be arranged internally or externally to the communication device.

FIGS. 1-3 illustrate various example architectures for a communications network 100 in which the various methods, apparatuses, and computer program products can be carried out and/or used. In some embodiments, the communications network 100 can comprise any suitable configuration, number, orientation, positioning, and/or dimensions of components and specialized equipment configured to provide an air interface (e.g., New Radio (NR)) for communication or connection between a User Equipment 102 (UE 102) and a Data Network 116 (DN 116) via a Core Network 101 (CN 101) of the communications network 100. The UE 102 can be associated with one or more devices associated with one or more network function (NF) service consumers. As illustrated in FIG. 1, a communications network 100 can be provided in which the UE 102 is in operable communication with the Radio Access Network 104 (RAN 104), such as by way of a transmission tower, a base station, an access point, a network node, and/or the like. In some embodiments, the RAN 104 can communicate with the CN 101 or a component or entity thereof. In some embodiments, the CN 101 can facilitate communication between the UE 102 and the DN 116, such as for sending data, messages, requests, the like, or combinations thereof. In some embodiments, the DN 116 or the CN 101 can be in communication with an Application Server or Application Function 112 (AS/AF 112). The RAN 104, CN 101, DN 116, and/or AS/AF 112 can be associated with a Network Repository Function (NRF), NF service producer, Service Communication Proxy (SCP), Security Edge Protection Proxy (SEPP), Policy Charging Function (PCF), the like, or combinations thereof.

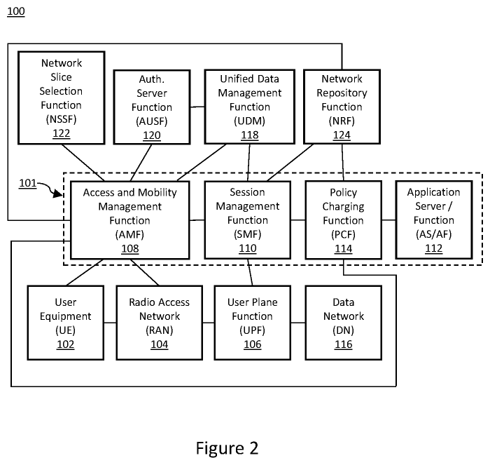

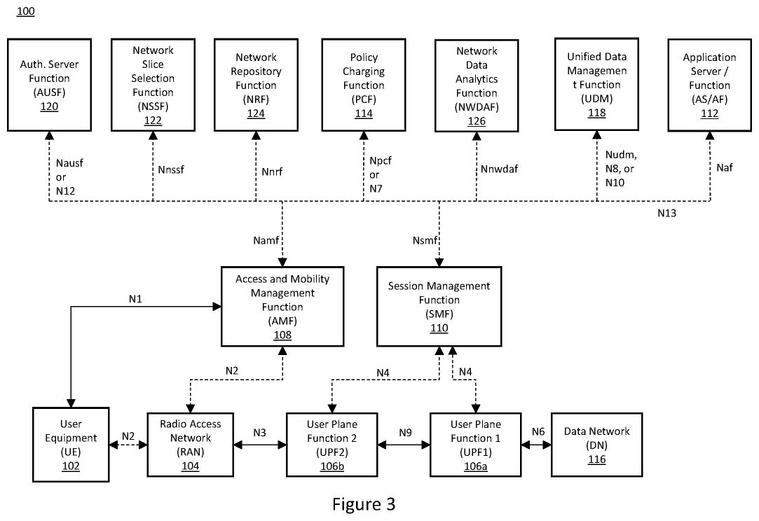

In the context of a 5G network, such as illustrated in FIGS. 2 and 3, the communications network 100 can comprise a series of connected network devices and specialized hardware that is distributed throughout a service region, state, province, city, or country, and one or more network entities, which can be stored at and/or hosted by one or more of the connected network devices or specialized hardware. In some embodiments, the UE 102 can connect to the RAN 104, which can then relay the communications between the UE 102 and the CN 101, the CN 101 being connected to the DN 116, which can be in communication with one or more AS/AF 112. In some embodiments, the UE 102 can be in communication with a RAN 104, which can act as a relay between the UE 102 and other components or services of the CN 101. For instance, in some embodiments, the UE 102 can communicate with the RAN 104, which can in turn communicate with an Access and Mobility Management Function 108 (AMF 108). In other instance or embodiments, the UE 102 can communicate directly with the AMF 108. In some embodiments, the AMF 108 can be in communication with one or more network functions (NFs), such as an Authentication Server Function 120 (AUSF 120), a Network Slice Selection Function 122 (NSSF 122), a Network Repository Function 124 (NRF 124), a Policy Charging Function 114 (PCF 114), a Network Data Analytics Function 126 (NWDAF 126), a Unified Data Management function 118 (UDM 118), the AS/AF 112, a Session Management Function 110 (SMF 110), and/or the like.

In some embodiments, the SMF 110 can be in communication with one or more User Plane Functions 106 (UPF 106, UPF 106a, UPF 106b, collectively “UPF 106”). By way of example only, in some embodiments, the UPF 106 can be in communication with the RAN 104 and the DN 116. In other embodiments, the DN 116 can be in communication with a first UPF 106a and the RAN 104 can be in communication with a second UPF 106b, while the SMF 110 is in communication with both the first and second UPFs 106a, b and the first and second UPFs 106a, b are in communication each with the other.

In some embodiments, the UE 102 can comprise a single-mode or a dual-mode device such that the UE 102 can be connected to one or more RANs (e.g., RAN 104). In some embodiments, the RAN 104 can be configured to implement one or more Radio Access Technologies (RATs), such as Bluetooth, Wi-Fi, and Global System for Mobile Communication (GSM), Universal Mobile Telecommunications System (UMTS), LTE or 5G NR, among others, that can be used to connect the UE 102 to the CN 101. In some embodiments, the RAN 104 can comprise or be implemented using a chip, such as a silicon chip, in the UE 102 that can be paired with or otherwise recognized by a similar chip in the CN 101, such that the RAN 104 can establish a connection or line of communication between the UE 102 and the CN 101 by identifying and pairing the chip within the UE 102 with the chip within the CN 101. In some embodiments, the RAN 104 can implement one or more base stations, towers or the like to communicate between the UE 102 and the AMF 108 of the CN 101.

In some embodiments, the communications network 100 or components thereof (e.g., base stations, towers, etc.) can be configured to communicate with a communication device (e.g., the UE 102) such as a cell phone or the like over multiple different frequency bands, e.g., FR1 (below 6 GHz), FR2 (mm Wave), other suitable frequency bands, sub-bands thereof, and/or the like. In some embodiments, the communications network 100 can comprise or employ massive Multiple Input and Multiple Output (MIMO) antennas. In some embodiments, the communications network 100 can comprise Multi-User MIMO (MU-MIMO) antennas. In some embodiments, the communications network 100 can employ edge computing whereby the computing servers are communicatively, physically, computationally, and/or temporally closer to the communications device (e.g., UE 102) in order to reduce latency and data traffic congestion. In some embodiments, the communications network 100 can employ other technologies, devices, or techniques, such as small cell, low-powered RAN, beamforming of radio waves, Wi-Fi cellular convergence, Non-Orthogonal Multiple Access (NOMA), channel coding, the like, or combinations thereof.

As illustrated in FIG. 3, the UE 102 can be configured to communicate with the CN 101 in a N1 interface, e.g., according to a Non-Access Stratum (NAS) protocol. In some embodiments, RAN 104 can be configured to communicate with the CN 101 or a component thereof (e.g., the AMF 108) in a N2 interface, e.g., in a control plane between a base station of the RAN 104 and the AMF 108. In some embodiments, the RAN 104 can be configured to communicate with the UPF 106 in a N3 interface, e.g., in a user plane. In some embodiments, the AMF 108 and/or the SMF 110 can be configured to communicate with other services or network entities within the CN 101 in various different interfaces and/or according to various different protocols. For instance, in some embodiments, the AMF 108 and/or the SMF 110 can be configured to communicate with the AUSF 120 in a Nausf interface or an N12 interface. In some embodiments, the AMF 108 and/or the SMF 110 can be configured to communicate with the NSSF 122 in a Nnssf interface. In some embodiments, the AMF 108 and/or the SMF 110 can be configured to communicate with the NRF 124 in a Nnrf interface. In some embodiments, the AMF 108 and/or the SMF 110 can be configured to communicate with the PCF 114 in a Npcf interface or an N7 interface. In some embodiments, the AMF 108 and/or the SMF 110 can be configured to communicate with the NWDAF 126 in a Nnwdaf interface. In some embodiments, the AMF 108 and/or the SMF 110 can be configured to communicate with the UDM 118 in a Nudm interface, an N8 interface, or an N10 interface. In some embodiments, the AMF 108 and/or the SMF 110 can be configured to communicate with the AS/AF 112 in a Naf interface. In some embodiments, the SMF 110 can be configured to communicate with the UPF 106 in a N4 interface, which can act as a bridge between the control plane and the user plane, such as acting as a conduit for a Protocol Data Unit (PDU) session during which information is transmitted between, e.g., the UE 102 and the CN 101 or components/services thereof.

It will be appreciated that certain example embodiments described herein arise in the context of a telecommunications network, including but not limited to a telecommunications network that conforms to and/or otherwise incorporates aspects of a fifth-generation (5G) architecture. While FIGS. 1-3 illustrate various configurations and/or components of an example architecture of the communications network 100, many other systems, system configurations, networks, network entities, and pathways/protocols for communication therein are contemplated and considered within the scope of this present disclosure.

While the methods, devices/apparatuses, and computer program products/codes described herein are described within the context of a fifth-generation core network (5GC) and system, such as illustrated in FIGS. 1-3 and described hereinabove, the described methods, devices, and computer program products can nevertheless be applied in a broader context within any suitable telecommunications system, network, standard, and/or protocol. It will be appreciated that the described methods, devices, and computer program products can further be applied to yet undeveloped future networks and systems as would be apparent to one skilled in the art in light of the present disclosure.

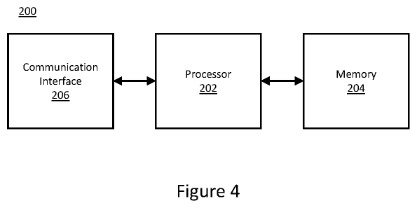

Turning now to FIG. 4, examples of an apparatus that may be embodied by the user equipment or by a network entity, such as server or other computing device are depicted in accordance with an example embodiment of the present disclosure. As described below in conjunction with the flowcharts and block diagrams presented herein, the apparatus 200 of an example embodiment can be configured to perform the functions described herein. In any instance, the apparatus 200 can more generally be embodied by a computing device, such as a server, a personal computer, a computer workstation or other type of computing device including those functioning as a user equipment and/or a component of a wireless network or a wireless local area network. Regardless of the manner in which the apparatus 200 is embodied, the apparatus of an example embodiment can be configured as shown in FIG. 4 so as to include, be associated with or otherwise be in communication with a processor 202 and a memory device 204 and, in some embodiments, and/or a communication interface 206.

Although not illustrated, the apparatus of an example embodiment may also optionally include a user interface, such as a touch screen, a display, a keypad, the like, or combinations thereof. Moreover, the apparatus according to example embodiments can be configured with a global positioning circuit that comprises a global positioning receiver and/or global positioning transmitter configured for communication with one or more global navigation satellite systems (e.g., GPS, GLONASS, Galileo, the like, or combinations thereof). The global positioning circuit may be configured for the transmission and/or receipt of direct/indirect satellite and/or cell signals in order to determine geolocation data (e.g., latitude, longitude, elevation, altitude, geographic coordinates, the like, or combinations thereof.) for the apparatus and/or another communication device associated with the apparatus or the one or more global navigation satellite systems.

The processor 202 (and/or co-processors or any other circuitry assisting or otherwise associated with the processor) can be in communication with the memory device 204 via a bus for passing information among components of the apparatus 200. The memory device can include, for example, one or more volatile and/or non-volatile memories, such as a non-transitory memory device. In other words, for example, the memory device can be an electronic storage device (e.g., a computer readable storage medium) comprising gates configured to store data (e.g., bits) that can be retrievable by a machine (e.g., a computing device like the processor). The memory device can be configured to store information, data, content, applications, instructions, the like, or combinations thereof for enabling the apparatus to carry out various functions in accordance with an example embodiment. For example, the memory device could be configured to buffer input data for processing by the processor. Additionally or alternatively, the memory device could be configured to store instructions for execution by the processor.

The apparatus 200 can, in some embodiments, be embodied in various computing devices as described above. However, in some embodiments, the apparatus can be embodied as a chip or chip set. In other words, the apparatus can comprise one or more physical packages (e.g., chips) including materials, components and/or wires on a structural assembly (e.g., a baseboard). The structural assembly can provide physical strength, conservation of size, and/or limitation of electrical interaction for component circuitry included thereon. The apparatus can therefore, in some cases, be configured to implement an embodiment of the present invention on a single chip or as a single “system on a chip.” As such, in some cases, a chip or chipset can constitute means for performing one or more operations for providing the functionalities described herein.

The processor 202 can be embodied in a number of different ways. For example, the processor can be embodied as one or more of various hardware processing means such as a coprocessor, a microprocessor, a controller, a Digital Signal Processor (DSP), a processing element with or without an accompanying DSP, or various other circuitry including integrated circuits such as, for example, an Application Specific Integrated Circuit (ASIC), a Field Programmable Gate Array (FPGA), a Micro-Controller Unit (MCU), a hardware accelerator, a special-purpose computer chip, or the like. As such, in some embodiments, the processor can include one or more processing cores configured to perform independently. A multi-core processor can enable multiprocessing within a single physical package. Additionally or alternatively, the processor can include one or more processors configured in tandem via the bus to enable independent execution of instructions, pipelining and/or multithreading.

In an example embodiment, the processor 202 can be configured to execute instructions stored in the memory device 204 or otherwise accessible to the processor. Alternatively or additionally, the processor can be configured to execute hard coded functionality. As such, whether configured by hardware or software methods, or by a combination thereof, the processor can represent an entity (e.g., physically embodied in circuitry) capable of performing operations according to an embodiment of the present disclosure while configured accordingly. Thus, for example, when the processor is embodied as an ASIC, FPGA, the like, or combinations thereof the processor can be specifically configured hardware for conducting the operations described herein. Alternatively, as another example, when the processor is embodied as an executor of instructions, the instructions can specifically configure the processor to perform the algorithms and/or operations described herein when the instructions are executed. However, in some cases, the processor can be a processor of a specific device (e.g., an encoder and/or a decoder) configured to employ an embodiment of the present invention by further configuration of the processor by instructions for performing the algorithms and/or operations described herein. The processor can include, among other things, a clock, an Arithmetic Logic Unit (ALU) and logic gates configured to support operation of the processor.

In embodiments that include a communication interface 206, the communication interface can be any means such as a device or circuitry embodied in either hardware or a combination of hardware and software that is configured to receive and/or transmit data from/to a network and/or any other device or module in communication with the apparatus 200, such as NF, NRF, a base station, an access point, SCP, UE 102, RAN 104, core network services, AS/AF 112, a database or other storage device, the like, or combinations thereof. In this regard, the communication interface can include, for example, one or more antennas and supporting hardware and/or software for enabling communications with a wireless communication network. Additionally or alternatively, the communication interface can include the circuitry for interacting with the one or more antennas to cause transmission of signals via the one or more antennas or to handle receipt of signals received via the one or more antennas. In some embodiments, the one or more antennas may comprise one or more of a dipole antenna, monopole antenna, helix antenna, loop antenna, waveguide, horn antenna, parabolic reflectors, corner reflectors, dishes, micro strip patch array, convex-plane, concave-plane, convex-convex, concave-concave lenses, the like or combinations thereof.

In some environments, the communication interface can alternatively or also support wired communication. As such, for example, the communication interface can include a communication modem and/or other hardware/software for supporting communication via cable, Digital Subscriber Line (DSL), USB, the like or combinations thereof. In some embodiments, a session management function (e.g., SMF 110) can comprise a 5GC session management function for any suitable Control and User Plane Separation (CUPS) architecture, such as for the General Packet Radio Service (GPRS), Gateway GPRS Support Node Control plane function (GGSN-C), Trusted Wireless Access Gateway Control plane function (TWAG-C), Broadband Network Gateway Control and User Plane Separation (BNG-CUPS), N4-Interface, Sxa-Interface, Sxb-Interface, Sxc-Interface, Evolved Packet Core (EPC) Serving Gateway Control plane function (SGW-C), EPC Packet Data Network Gateway Control plane function (PGW-C), EPC Traffic Detection Control plane function (TDF-C), the like, or combinations thereof.

As illustrated, the apparatus 200 can include a processor 202 in communication with a memory 204 and configured to provide signals to and receive signals from a communication interface 206. In some embodiments, the communication interface 206 can include a transmitter and a receiver. In some embodiments, the processor 202 can be configured to control the functioning of the apparatus 200, at least in part. In some embodiments, the processor 202 can be configured to control the functioning of the transmitter and receiver by effecting control signaling via electrical leads to the transmitter and receiver. Likewise, the processor 202 can be configured to control other elements of apparatus 200 by effecting control signaling via electrical leads connecting the processor 202 to the other elements, such as a display or the memory 204.

The apparatus 200 can be capable of operating with one or more air interface standards, communication protocols, modulation types, access types, and/or the like. Signals sent and received by the processor 202 can include signaling information in accordance with an air interface standard of an applicable cellular system, and/or any number of different wireline or wireless networking techniques, comprising but not limited to Wi-Fi, Wireless Local Access Network (WLAN) techniques, such as Institute of Electrical and Electronics Engineers (IEEE) 802.11, 802.16, 802.3, Asymmetric Digital Subscriber Line (ADSL), Data Over Cable Service Interface Specification (DOCSIS), the like, or combinations thereof. In addition, these signals can include speech data, user generated data, user requested data, the like, or combinations thereof.

For example, the apparatus 200 and/or a cellular modem therein can be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, Session Initiation Protocol (SIP)), the like, or combinations thereof. For example, the apparatus 200 can be capable of operating in accordance with 2G wireless communication protocols Interim Standard (IS) 136 (IS-136), Time Division Multiple Access (TDMA), GSM, IS-95, Code Division Multiple Access, Code Division Multiple Access (CDMA), the like, or combinations thereof. In addition, for example, the apparatus 200 can be capable of operating in accordance with 2.5G wireless communication protocols GPRS, Enhanced Data GSM Environment (EDGE), the like, or combinations thereof. Further, for example, the apparatus 200 can be capable of operating in accordance with 3G wireless communication protocols, such as UMTS, Code Division Multiple Access 2000 (CDMA2000), Wideband Code Division Multiple Access (WCDMA), Time Division-Synchronous Code Division Multiple Access (TD-SCDMA), the like, or combinations thereof. The NA 200 can be additionally capable of operating in accordance with 3.9G wireless communication protocols, such as Long Term Evolution (LTE), Evolved Universal Terrestrial Radio Access Network (E-UTRAN), the like, or combinations thereof. Additionally, for example, the apparatus 200 can be capable of operating in accordance with 4G wireless communication protocols, such as LTE Advanced, 5G, and/or the like as well as similar wireless communication protocols that can be subsequently developed. In some embodiments, the apparatus 200 can be capable of operating according to or within the framework of any suitable CUPS architecture, such as for the gateway GGSN-C, TWAG-C, Broadband Network Gateways (BNGs), N4-Interface, Sxa-Interface, Sxb-Interface, Sxc-Interface, EPC SGW-C, EPC PGW-C, EPC TDF-C, the like, or combinations thereof. Indeed, although described herein in conjunction with operation with a 5G system, the apparatus and method may be configured to operate in conjunction with a number of other types of systems including systems hereinafter developed and implemented.

Some of the embodiments disclosed herein can be implemented in software, hardware, application logic, or a combination of software, hardware, and application logic. The software, application logic, and/or hardware can reside on memory 204, the processor 202, or electronic components, for example. In some example embodiments, the application logic, software or an instruction set is maintained on any one of various conventional computer-readable media. In the context of this document, a “computer-readable medium” can be any non-transitory media that can contain, store, communicate, propagate or transport the instructions for use by or in connection with an instruction execution system, apparatus, or device, such as a computer or data processor circuitry, with examples depicted at FIG. 4. The computer-readable medium can comprise a non-transitory computer-readable storage medium that can be any media that can contain or store the instructions for use by or in connection with an instruction execution system, apparatus, or device, such as a computer.

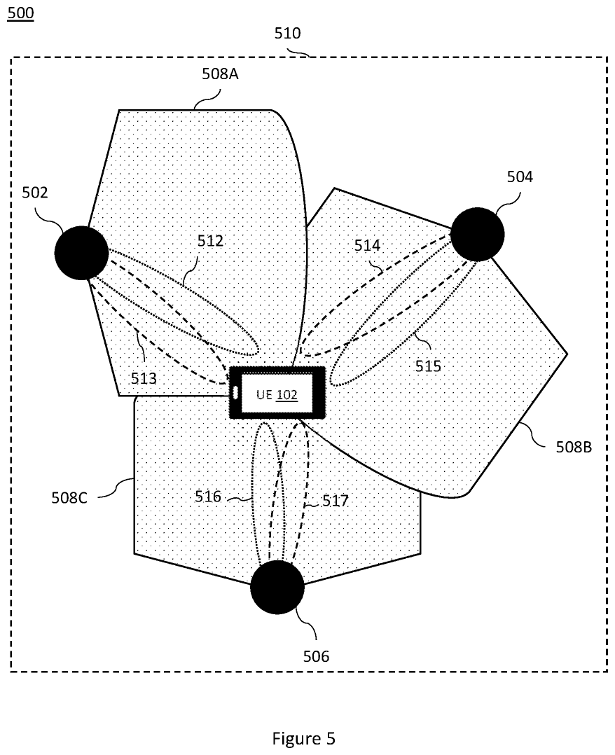

FIG. 5 illustrates an example architecture for a communications network 500 of coverage area 510, according to some embodiments. The communications network 500 comprises at least three base stations (e.g., gNB, etc.) of a RAN (e.g., RAN 104 or the like), such as base station 502, base station 504, and base station 506. Each base station may be communicably connected, at least temporarily, to UE 102 via a respective beam. As illustrated, base station 502 serves at least cell 508A and may be in communication with UE 102 via at least beam 512 and/or beam 513. Base station 504 serves at least cell 508B and may be in communication with UE 102 via at least beam 514 and/or beam 515. Base station 506 serves at least cell 508C and may be in communication with UE 102 via at least beam 516 and/or beam 517. In some embodiments, one or more of the base stations (e.g., 502, 504, 506 or the like) may serve one or more additional cells (not shown) in at least coverage area 510. For example, each base station may serve at least three cells serving a portion of coverage area 510. Moreover, all of coverage area 510 may be served by a plurality of cells facilitated by the base station 502, base station 504, and base station 506. It should be appreciated that the plurality of cells of a respective base station may cover at least a concentric area surrounding the respective base station. Each cell may transmit and/or receive data via respective beams.

The UE 102 may utilize at least Communication Interface 206 to establish one or more network connections by way of causing transmission and receipt of communication signals between the UE 102 via at least Communication Interface 206 and one or more of the base stations (e.g., 502, 504, 506 or the like). It will be appreciated that as the UE 102 moves out of range of one or more cells and into range of one or more other cells handover procedures may be executed to transition the UE 102 from a first serving cell to a target cell selected based on one or more conditions (e.g., signal strength, etc.). In some embodiments, Communication Interface 206 of the UE 102 may be communicably connected to one or more of a RAN, next generation RAN (NG-RAN), cell, beam, gNB, next generation eNodeB (ng-eNB), NodeB, network function, network entity, the like, or combinations thereof such that communication signals can be transmitted and received therethrough. In some embodiments, the communication network 500 of FIG. 5 may comprise one or more of a Public Land Mobile Network (PLMN), Stand-Alone Non-Public Network (SNPN), a Public Network Integrated NPN (PNI-NPN), and/or the like.

As shown, in FIG. 5, the UE 102 is at least temporarily static, without at least linear movement, at the edge between cell 508A, cell 508B, and cell 508C. The UE 102 is within range of at least beam 512 and beam 513 associated with cell 508A, beam 514 and beam 515 associated with cell 508B, and beam 516 and beam 517 associated with cell 508C. It should be appreciated, in light of the present disclosure, that even if the UE 102 is static with respect to linear movement (e.g., walking around coverage area 510, etc.), frequent and/or continuous handovers between cells 508A, 508B, and/or 508C may be triggered by, for example, rotation of the UE 102 and/or the presence of signal blockers (e.g., walls, moving objects, cars, etc.).

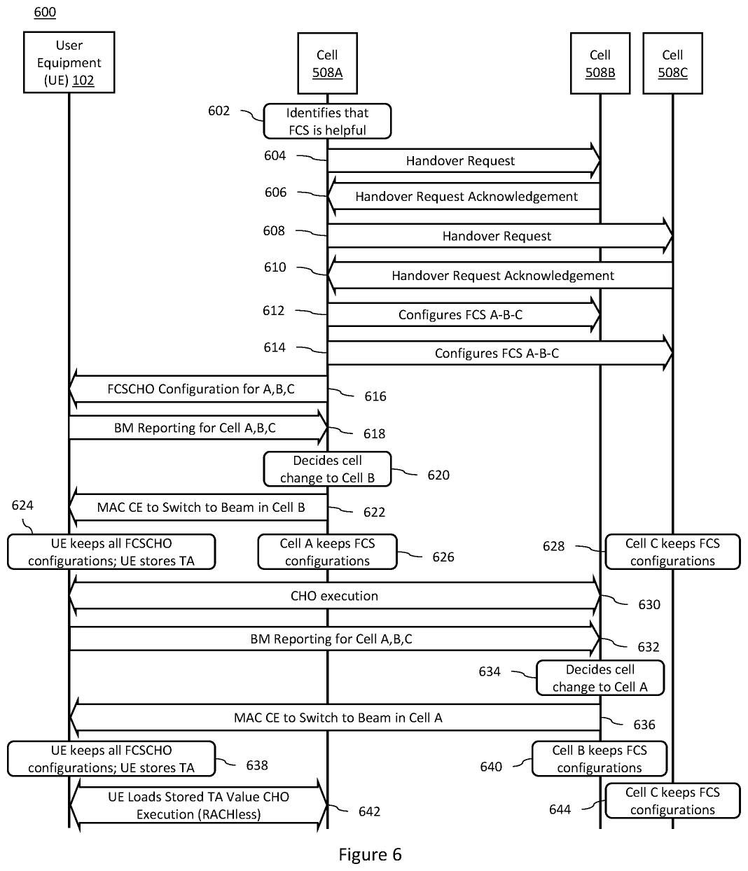

For example, coverage area 510 may comprise a warehouse with forklifts being driven around the UE 102 (e.g., placed on the surface of a desk, etc.). As a forklift passes between UE 102 and a respective base station, a beam may be temporarily blocked, and a handover may be triggered to another cell and then back once the forklift has passed or another handover may occur due to another blocker (e.g., another forklift passing between the UE 102 and another cell, base station, and/or beam). It should be further appreciated that such high frequency cell changes (e.g., handovers, etc.) may be caused by one or more of blocked radio propagation due to small beam wavelengths (e.g., by a car, a forklift, the hand/body of a user, etc.), the use of narrow beams, rotation of the UE (e.g., spherical coverage of a cell, or the like, around the UE may not be 100%), or the like. In some embodiments, the communications network 500 of coverage area 510 may comprise a centralized deployment architecture such that the cells, base stations, and/or other distributed units may be hosted by a common Central Unit (CU). In some embodiments, a centralized deployment may be configured to lower the latency of communications. Improved handover procedures (e.g., FCSCHO configurations, etc.) for handling various rapid or repeated handover scenarios, such as those discussed above with respect to FIG. 5, will now be described in further detail with respect to FIGS. 6-9. In some embodiments, the procedures described with respect to FIGS. 6-9 may be used at least in part to improve conditional handovers or other procedures for cell switching.

FIG. 6 illustrates a flow chart that depicts an example signal sequence 600, for the provision of at least a conditional handover using FCSCHO configurations, between communication devices (e.g., UE 102, gNBs, apparatus 200, etc.) by way of at least a network infrastructure (e.g., communications network 100, 500, etc.). As shown, the example network infrastructure utilized for signal sequence 600 comprises at least UE 102, cell 508A, cell 508B, and 508C. Each of the cells may be supported by one or more base stations (e.g., gNBs, etc.), such as base stations 502, 504, 506, and/or the like. In some embodiments, the network infrastructure may be configured in accordance with 5G system standards, or the like (e.g., 4G, LTE, etc.), and that the serving RAN (e.g., RAN 104 or the like) can comprise one or more 5G radio nodes, such as one or more gNBs or equivalent. In some embodiments, the example signal sequence 600 may be implemented utilizing one or more network infrastructures associated with one or more networks (e.g., PLMN, SNPN, etc.) and each of the one or more networks may comprise one or more network slices.

As illustrated signal sequence 600 begins at block 602, the UE 102 is connected to cell 508A; cell 508A or a device associated therewith (e.g., gNB, apparatus 200, network server, etc.) identifies (e.g., detects, determines, etc.) that using the FCS mode will be helpful for handling handovers associated with UE 102 and at least some neighboring cells (e.g., cell 508B and cell 508C). In some embodiments, cell 508A may determine that FCS mode will be utilized (e.g., helpful, etc.) for cell switching based on one or more of a configuration of UE 102 (e.g., configured by the serving network, etc.), historical data associated with UE 102 and/or the serving network (e.g., a previous determination made for the UE and/or the network by one or more network entities, etc.), a predefined threshold (e.g., a number of handovers being initiated with respect to a time period, etc.), or the like.

At block 604, cell 508A causes transmission of a handover request to cell 508B and the handover request is acknowledged at block 606 by cell 508B via a response transmission (e.g., caused by at least cell 508B) to at least cell 508A. At block 608, cell 508A causes transmission of a handover request to cell 508C and the handover request is acknowledged at block 610 by cell 508C via a response transmission (e.g., caused by at least cell 508C) to at least cell 508A. The handover requests transmitted between cell 508A and cell 508B and/or 508C may be configured to at least prepare the target cells (i.e., cell 508B and cell 508C) for the FCSCHO procedures. In some embodiments, one or more handover requests, and/or one or more handover request acknowledgements, may comprise further information to facilitate FCSCHO procedures. For example, the handover requests, and/or acknowledgements, may comprise information that the CHO preparations (e.g., FCSCHO preparations, etc.) are part of a new operational mode (e.g., FCS operational mode, etc.). Moreover, the handover requests, and/or acknowledgements, may comprise information about one or more beams, associated with one or more cells and/or base stations, that the UE 102 may be switched to a neighboring cell. For example, the handover requests, and/or acknowledgements, may comprise Transmission Configuration Indicator (TCI) states or the like.

At block 612, cell 508A causes transmission of FCS configuration information associated with at least a plurality of cells to cell 508B. At block 614, cell 508A causes transmission of FCS configuration information associated with at least a plurality of cells to cell 508C. The FCS configuration information may provide for toggling among the plurality of cells comprising at least cell 508A, cell 508B, and cell 508C. The FCS configuration information causes each cell of the plurality of cells to be aware of each other and of the UE context of the UE 102. For example, cell 508A informs cell 508B, via the FCS configuration information, that cell 508A and cell 508C are prepared for FCSCHO and further cell 508A informs cell 508C, via the FCS configuration information, that cell 508A and cell 508B are prepared for FCSCHO.

In some embodiments, the FCS configuration information may provide configurations for a base station, or other device, associated with a cell that facilitates use of the FCS operational mode. In some embodiments, the FCS configuration information is generated, based on at least an FCS operational mode, by one or more of the plurality of cells (e.g., cell 508A, cell 508B, cell 508C, or the like), computing devices (e.g., base stations, servers, etc.) associated with at least a cell of the plurality of cells, the UE 102, a network entity, or the like. For example, one or more target cells (e.g., cell 508B and/or cell 508C) may cause transmission of additional FCS configuration information back to serving cell (e.g., cell 508A) in response to the FCS configuration information received from serving cell.

At block 616, cell 508A causes transmission of the FCSCHO configuration information associated with the plurality of cells (e.g., cell 508A, cell 508B, cell 508C, or the like) to the UE 102. In some embodiments, the FCSCHO configuration information of block 616 may comprise the additional FCS configuration information provided by one or more target cells to the serving cell. In some embodiments, the FCSCHO configuration information of block 616 may comprise additional FCS configuration information associated with the serving cell itself (e.g., cell 508A), for example for the UE 102 to perform a return handover from another cell back to the serving cell. In some embodiments, the FCSCHO configuration information of block 616 may comprise CHO conditions at each cell of the plurality of cells, a beam management reporting configuration (e.g., for intercell Beam Management (BM) reporting, etc.), Random Access Channel (RACH)-less handover information, or the like. It will be appreciated that upon receipt of the FCSCHO configuration information by the UE 102, the setup configuration of the FCS operational mode is completed for the UE 102 and the current plurality of cells, so that FCSCHOs may be performed between the UE 102 and the currently configured plurality of cells.

At block 618, the UE 102 causes transmission of the BM reporting information to cell 508A, such as in response to receipt of the FCSCHO configuration information associated with the plurality of cells. In some embodiments, the BM reporting information may comprise intra-cell and/or inter-cell BM reporting and the BM reporting information may be generated by UE 102 based on at least the FCSCHO configuration information and/or BM measurement information. For example, as illustrated with respect to FIG. 5, the UE 102 may be configured to report beam 512 and/or beam 513 of cell 508A, beam 514 and/or beam 515 of cell 508B, and beam 516 and/or 517 of cell 508C to the serving cell (e.g., cell 508A). Based on at least the received BM reporting information (e.g., BM reports, etc.) cell 508A (i.e., the serving cell) decides (e.g., determines, detects, etc.) that the UE 102 should change (e.g., switch, etc.) to cell 508B by executing one or more procedures (e.g., FCSCHO, slimCHO, or the like), see block 620. In some embodiments, the determination made by cell 508A for UE 102 to switch to cell 508B may be based on one or more of a beam metric (e.g., signal strength, etc.), a movement of UE 102 (e.g., detection of linear movement, rotation, no movement/static position, a direction toward/away from a cell, etc.), or the like.

At block 622, cell 508A causes transmission of the Medium Access Control (MAC) Control Element (CE) to cause the UE 102 to switch from cell 508A (e.g., and one or more associated beams) to beam 514 and/or beam 515 of cell 508B. In some embodiments, the serving cell may instruct the UE via one or more MAC CE to execute the CHO (e.g., FCSCHO, slimCHO, or the like), for example to switch to a particular beam of a target neighboring cell (e.g., beam 514 and/or 515 of cell 508B). Upon receipt of the MAC CE instructions, the UE 102 keeps (e.g., stores via memory, etc.) all FCSCHO configurations and/or stores Timing Advance (TA) information (e.g., for cell 508A for later usage), see block 624. In some embodiments, the UE 102 may utilize conventional random access memory or the like for storage procedures.

At block 626, cell 508A determines to keep (e.g., stores via memory, etc.) all FCSCHO configurations. At block 628, cell 508C determines to keep (e.g., stores via memory, etc.) all FCSCHO configurations. In some embodiments, all FCSCHO configured cells (e.g., 508A, 508B, and 508C) determine to keep (e.g., stores via memory, etc.) all FCSCHO configurations associated with all of the FCSCHO configured cells and the associated UE. At block 630, CHO (e.g., FCSCHO, slimCHO, or the like) procedures are executed between the UE 102 and the new serving cell identified as cell 508B. The executed CHO (e.g., FCSCHO, slimCHO, or the like) procedures of block 630 cause UE 102 to be served by cell 508B. At block 632, the UE 102 causes transmission of the BM reporting information to cell 508B, such as in response to an elapse time period or other detected condition to trigger BM reporting information. In some embodiments, the BM reporting information may comprise intra-cell and/or inter-cell BM reporting and the BM reporting information may be generated by UE 102 based on at least the FCSCHO configuration information and/or BM measurement information.

Based on at least the received BM reporting information of block 632 (e.g., BM reports for cells 508A-C, etc.) cell 508B (i.e., the serving cell) decides (e.g., determines, detects, etc.) that the UE 102 should change (e.g., switch, handover, etc.) to cell 508A by executing one or more CHO procedures (e.g., FCSCHO, slimCHO, or the like), see block 634. At block 636, cell 508B causes transmission of the MAC CE to cause the UE 102 to switch from cell 508B to beam 512 and/or beam 513 of cell 508A. At block 638, the UE 102 determines to keep (e.g., store via random access memory, etc.) all FCSCHO configurations for the plurality of configured cells and/or stores TA information (e.g., for cell 508B for later usage). At block 640, cell 508B determines to keep (e.g., store via random access memory, etc.) all FCSCHO configurations for the plurality of configured cells.

At block 642, the UE 102 loads (e.g., from memory, etc.) the stored TA information (e.g., values, etc.) for CHO execution (e.g., RACH-less or the like). In some embodiments, the UE 102 may use the previously stored TA information of cell 508A (e.g., stored at block 624) to execute a RACH-less handover. At block 644, cell 508C keeps (e.g., stores) all FCS configurations for the plurality of cells associated with the UE 102. It should be appreciated that the UE 102 may continue to toggle between at least the plurality of configured cells (e.g., cells 508A-C) without increasing signaling overhead because the handover configurations (e.g., FCSCHO configurations, etc.) are already prepared and continued to be stored by the UE and cells. The FCSCHO configurations may be prepared and transmitted only once and switching may occur without further preparation (e.g., signaling between the UE and cells).

In some embodiments, as shown in FIG. 6 the signal sequence 600 that provides for at least conditional handovers using the FCSCHO configurations may be handled, at least partially, by a Central Unit (CU) associated with the plurality of cells (e.g., cells 508A-C, etc.). It should be appreciated, in light of the present disclosure, that the CU is a node that includes, at least some of, the base station (e.g., gNB, etc.) functionality (e.g., UE data transmission, etc.), mobility control, Radio Resource Control (RRC), RAN sharing, positioning, session management, and other network entity functionality (e.g., attributed to the RAN, AMF, SMF, or the like). The CU may be communicably connected to one or more of a distributed unit, a core network, a computing device (e.g., server, apparatus 200, etc.), or the like.

In some embodiments, the security key is not changed which simplifies the procedures of signal sequence 600. The CU may be utilized throughout a plurality of network deployment environments, for example industrial environments such as warehouses, manufacturing plants, or the like. Such network deployment environments may comprise a lesser number of cells and/or tighter (e.g., greater, etc.) latency requirements that may benefit from a CU deployment. However, the CU deployment may be beneficial in non-industrial environments because centralized deployments improve pooling gains. Moreover, such a centralized deployment where the involved cells share a common CU (e.g., a “intra-CU case”) is quite relevant throughout multiple network deployment environments (e.g., public spaces, shopping centers, subways, parks, cruise ships, or the like)

In some embodiments, the RAN (e.g., RAN 104 or the like) may comprise one or more of a base station, cell, beam, central unit, server, communications interface, or the like. In some embodiments, the RAN may be deployed in one or more coverage areas comprising one or more of an industrial environment (e.g., nuclear plant, etc.), non-industrial environment (e.g., public park, etc.), commercial environment (e.g., retail store, etc.), recreational environment (e.g., amusement park, etc.), residential environment (e.g., single family house, apartment building, townhome community, retirement community, etc.), or the like. In some embodiments, cell 508A (e.g., a serving cell, a first cell, etc.) informs cell 508B (e.g., target cell, a second cell, etc.) and/or cell 508C (e.g., target cell, a third cell, etc.) via the handover request message that one or more of the cells is an FCS preparation.

In some embodiments, the UE causes transmission of information to the new serving cell after a slimCHO occurs to inform the new serving cell about the plurality of cells associated with the new operational mode (e.g., FCS mode). For example, after CHO execution (e.g., block 630 of FIG. 6) the UE 102 would cause transmission of information to inform the new serving cell 508B that cell 508C and cell 508A are configured for CHO (e.g., FCSCHO, etc.). Further, causing transmission of information to inform the new serving cell about the plurality of cells configured for the new operational mode may be performed in place of the serving cell causing transmission of FCS configurations to the plurality of cells. For example, if the UE 102 informs the new serving cell (e.g., cell 508B), after slimCHO, of cell 508A and cell 508C then the previous operations described with respect to block 612 and block 614 from the first serving cell (e.g., cell 508A) to cell 508B and cell 508C are not necessary and may be skipped. Moreover, the first serving cell (i.e., cell 508A) may be configured to save the FCS configuration information associated with at least the plurality of cells described with respect to the operations of block 612 and 614.

In some embodiments, if the current serving cell determines that another slimCHO is required (e.g., desired, necessary, etc.) and the current serving cell sends a MAC CE (e.g. as performed by cell 508A in block 622 of FIG. 6), then the current serving cell may cause transmission of the latest (e.g., most recent, etc.) BM measurements received via the UE's BM reporting transmission to the next serving cell (e.g. cell 508B). For example, if cell 508A causes transmission of the BM reporting information to cell 508B at or before the operations described with respect to block 632 of FIG. 6 then the UE may not perform at least some of the operations of block 632. It should be appreciated, in light of the present disclosure, that by providing the BM reporting information from the current serving cell to the next serving cell the system avoids extended wait times associated with receiving the first BM measurements directly from the UE.

In some embodiments, BM measurements (e.g., BM reporting information, etc.) may be transmitted to the new serving cell prior to the operations described with respect to block 632 of FIG. 6. In some embodiments, BM measurements (e.g., BM reporting information, etc.) may be transmitted to one or more cells (e.g., the new serving cell, etc.) at predefined time intervals (e.g., every 80 millisecond (ms), 160 ms, or the like). In some embodiments, the predefined time intervals that BM measurements (e.g., BM reporting information, etc.) may be transmitted to one or more cells (e.g., the new serving cell, etc.) may be dynamically adjusted (e.g., the predefined time interval may be dynamically increase or decrease at least once). For example, BM reporting information may be transmitted every 80 ms and after a set number of transmissions or after a predefined time interval has elapsed additional BM reporting information may be transmitted every 160 ms.

In some embodiments, the previous serving cell (e.g., cell 508A as described above with respect to FIG. 6), which configures the new operational mode (e.g., FCS operational mode or the like), determines that the new operational mode may be utilized (e.g., useful for the current UE behavior and environment, etc.) by using historical data (e.g., via machine learning, self-organizing methods, or the like). For instance, if many conventional handovers have happened in a particular time period (e.g., a short time period/interval, a predefined time period/interval, or the like) between a plurality of cells and the UE, then this may be an indication that the new operational mode may be applied to this UE and/or the plurality of cells.

In some embodiments, historical data comprises one or more of a location of a UE, a pathway and/or direction traversed by a UE, a number of handovers, a number of times a particular cell has been the serving cell for a particular UE, a time period/interval, a handover threshold, a time period/interval threshold, metadata associated with a UE/cell/network, historical logs of a UE/cell/network, or the like. For example, a serving cell may determine to use FCS mode based on a determination that the UE has remained in the same 500 square foot coverage area, served by the same plurality of cells, for at least 5 minutes, but has changed the serving cell among the plurality of cells at least 5 times. In some embodiments, the coverage area may cover a plurality of levels (e.g., floors in a building, etc.) and thus the coverage area may comprise a three-dimensional space (e.g., 100 cubic meters or the like). In some embodiments, a RAN, or portion thereof, may serve a plurality of levels.

In some embodiments, the MAC CE triggering of the CHO is used in addition to (e.g., not instead of) the conventional CHO condition. In some embodiments, the conventional CHO condition can be used as a fall back in an instance the MAC CE triggering of the CHO has failed (e.g., in not responsive, the transmission is lost, etc.). In an instance the MAC CE is lost due to bad radio conditions then the UE may still execute the CHO autonomously and thereby avoid a handover failure. Moreover, the CHO condition may be configured to trigger at a later time to give the MAC CE triggering a sufficient amount of time to cause the slimCHO procedures to initiate, run, and complete. In some embodiments, the UE may cause transmission of (e.g., send, transmit, etc.) an indication to a new serving cell in response to one or more of a MAC CE, a conventional CHO condition, or the like.

In some embodiments, a serving cell (e.g., cell 508A, etc.) may de-configure the FCS configurations for the plurality of cells (e.g., cells 508A-C, etc.) by causing transmission (e.g., sending, transmitting, etc.) of a de-configuration message to one or more of the plurality of FCS configured cells (e.g., cell 508B, 508C, etc.). In some embodiments, one or more of the plurality of cells (e.g., cell 508B, 508C, etc.) may request a de-configuration of the FCS configurations for the plurality of cells by informing the serving cell (e.g., causing transmission of a de-configuration request message to the serving cell). For example, cell 508B and/or 508C may determine that they may no longer be able to reserve resources (e.g., computing resources, processing power, memory space, communication channels, etc.) for the UE 102 associated with an FCS operational mode and in response cell 508B and/or 508C may cause transmission of a de-configuration request message to cell 508A (e.g., the serving cell). In some embodiments, a de-configuration request message may be generated and/or transmitted based on a determination that the UE is no longer within a coverage area of one or more cells of the plurality of FCS configured cells. In some embodiments, one or more cells may be de-configured from the plurality of FCS configured cells. For example, cell 508C may be de-configured from the plurality of FCS configured cells and cell 508A and 508B may remain configured in the plurality of FCS configured cells. In some embodiments, another cell may be configured into the plurality of FCS configured cells to replace one or more de-configured cells based on, for example, a new location of the UE (e.g., within a new coverage area that may comprise at least partially some of the previous coverage area).

In some embodiments, the FCSCHO configurations (e.g., at least partially generated by cells 508A-C via at least the handover requests and acknowledgements transmitted in blocks 604-610 of FIG. 6) may contain Contention-Free Random Access (CFRA) resources. In some embodiments, the CFRA resources comprise dedicated preambles which are valid for a specific beam. For example, FCSCHO configuration of cell 508A may contain at least two dedicated preambles, a first preamble for beam 512 and a second preamble for beam 513. Further, the FCSCHO configuration of cell 508B may contain at least two dedicated preambles, a first preamble for beam 514 and a second preamble for beam 515. The FCSCHO configuration of cell 508C may contain at least two dedicated preambles, a first preamble for beam 516 and a second preamble for beam 517. The CFRA resource may be configured to accelerate the FCS operational mode. For example, if a UE is stationary (e.g., not moving, static, etc.) or considered to be relatively stationary (e.g., the gNB transmission beams won't become outdated, etc.) then CFRA resources may only be reserved for one or more beams of a plurality of beams (e.g., all beams associated with the plurality of FCS configured cells). It should be appreciated, in light of the present disclosure, that the use of CFRA resources consumes less resources than conventional methods (e.g., CoMP that requires the UE to have simultaneous connections to the cells, etc.) that require continuously reserved resources at each cell (e.g. Physical Downlink Control Channel (PDCCH) and/or Physical Uplink Control Channel (PUCCH) reference signals, etc.).

In some embodiments, a plurality of cells (e.g., FCSCHO configured cells, etc.) may be updated (e.g., cell may be added or removed, new reporting information may be determined, etc.). For example, a cell of the plurality of cells may be determined to have too weak of a signal and therefore is determined to no longer be a viable serving/target cell and is removed from the plurality of cells (e.g., by the serving cell, the UE, the respective cell itself, or the like). Moreover, a cell that is not associated with the plurality of cells (e.g., FCSCHO configured cells, etc.) may become a more viable serving/target cell (e.g., determined to have a stronger/improving signal strength, etc.) and in response the cell may be added to the plurality of cells. In some embodiments, one or more cells may be added to or removed from the plurality of cells by cancelling the current FCS operational mode, and/or FCS configurations, and then setting up another FCS operational mode, and/or FCS configurations, as described above with respect to FIG. 6. It should be appreciated, in light of the present disclosure, that cancelling and setting up another FCS operational mode may reduce the likelihood of causing any race conditions or similar problems.

In some embodiments, a current serving cell may perform one or more preparation operations (e.g., determine BM reporting information for a respective cell, cause transmission of a cancel/remove request to a respective cell, etc.) to cancel a respective cell from a plurality of cells (e.g., remove the respective cell from the plurality of FCSCHO configured cells). In some embodiments, a current serving cell may perform one or more preparation operations (e.g., determine BM reporting information for a respective cell, cause transmission of an add/handover request to a respective cell, etc.) to add a respective cell to a plurality of cells (e.g., remove the respective cell from the plurality of FCSCHO configured cells). In some embodiments, a current serving cell may update information associated with the plurality of cells to reflect one or more added cells and/or one or more removed/canceled cells. For example, the serving cell may receive a request acknowledgment from one or more of an added, removed, or canceled cell and in response the serving cell may update the FCS configuration information or the like.

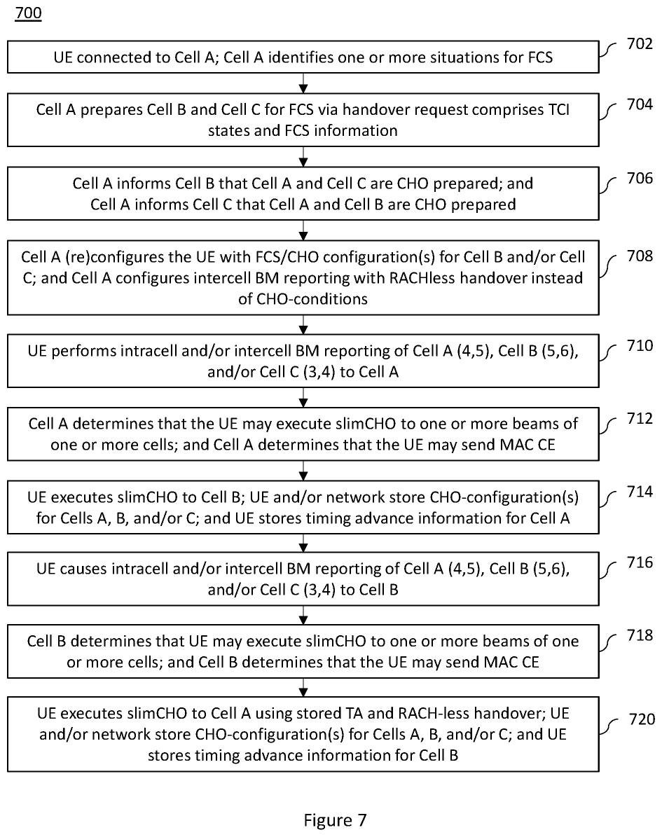

FIG. 7 illustrates a flowchart of example operations 700 for the provision of at least a conditional handover using FCSCHO configurations, between communication devices (e.g., UE 102, gNBs, apparatus 200, etc.) by way of at least a network infrastructure (e.g., communications network 100, 500, etc.). The example network infrastructure utilized for execution of example operations 700 comprises at least cells 508A-C and UE 102. In some embodiments, one or more of the operations described with respect to FIG. 7 may be executed by a system (e.g., of one or more of the network entities, etc.) in accordance with at least some of the signals described above with respect to FIG. 6.

At block 702, a UE is connected to a first cell (e.g., serving cell, cell A, cell 508A, etc.) and the first cell identifies (e.g., determines, etc.) one or more situations for use with an FCS operational mode. For example, the first cell may be configured with an FCS configuration that identifies handover scenarios and/or conditions to identify handover instances that would benefit from FCSCHO techniques. At block 704, the first cell (e.g., cell A) prepares a second cell (e.g., target cell, cell B, cell 508B, etc.) and a third cell (e.g., target cell, cell C, cell 508C, etc.) for FCS operational mode via at least a handover request. The handover request may comprise one or more of TCI states or FCS configuration information. The handover request, from the first cell, comprises at least an indication that the prepared cells are now in an FCS group. At block 706, the first cell informs the second cell that the first cell and the third cell are CHO prepared. Additionally, the first cell informs the third cell that the first cell and the second cell are CHO prepared. Thus, the first cell mutually introduces the second cell and the third cell such that each cell is in the FCS group with the first cell, meaning that when the UE enters a given cell from another given cell the beam reporting configurations are updated according to the FCS group (e.g., when in the first cell, the UE is configured to also report beam information related to the second cell and the third cell).

At block 708, the first cell may configure, or reconfigure, the UE with one or more CHO (e.g., FCSCHO, etc.) configurations associated with the second cell and/or the third cell. Additionally, the first cell may configure intercell, and/or intracell, BM reporting instead of, or in addition to, CHO conditions (e.g., FCSCHO conditions, etc.) at the UE (e.g., via transmission of configuration information, or the like). In some embodiments, the UE configuration, or reconfiguration, may comprise one or more of a CHO configuration for one or more cells of the FCS group of cells, CHO configuration with condition(s), CHO configuration without condition(s), MAC CE switching configuration, RACH-less configuration, BM reporting configuration, or the like.

At block 710, the UE performs intracell, and/or intercell, BM reporting of the first cell associated with beam 512 and beam 513, the second cell associated with beam 514 and 515, and/or the third cell associated with beam 516 and 517 to the first cell (e.g., the serving cell, cell A, cell 508A, etc.). In some embodiments, a cell may be associated with a plurality of beams. For example, as shown with respect to FIG. 5, cell 508A is associated with beam 512 and beam 513. At block 712, the first cell determines that the UE may execute slimCHO procedures to one or more beams of one or more cells. Additionally, the first cell may determine to send MAC CE to the UE to switch to another cell (e.g., the second cell, etc.). In some embodiments, the first cell (e.g., serving cell, etc.) may indicate a target cell to the UE, such as the second cell, the third cell, or the like.

At block 714, the UE executes slimCHO procedures to switch to the second cell (e.g., the target cell identified by the first cell while acting as the serving cell) and the UE and/or network may store all of the CHO-configurations for all of the cells of the FCS group (e.g., the first cell, second cell, third cell, or the like). Additionally, the UE may store TA information for the first cell, that was the previous serving cell, in case the UE is required to switch back to the first cell from the second cell or another serving cell. At block 716, the UE causes intracell, and/or intercell, BM reporting of the first cell associated with beam 512 and beam 513, the second cell associated with beam 514 and 515, and/or the third cell associated with beam 516 and 517 to the second cell (e.g., the current serving cell, cell B, cell 508B, etc.). In some embodiments, one or more additional cells (e.g., a fourth cell, etc.) may be detected (e.g., by the UE, by the serving cell, etc.), added to the FCS group of cells, and/or reported by the UE's BM reporting to the serving cell.

At block 718, the second cell (e.g., current serving cell, etc.) determines that the UE may execute slimCHO procedures, or the like, directed toward one or more beams of one or more cells (e.g., of the FCS group of cells, etc.). Additionally, the second cell may determine to send MAC CE to the UE to switch to another cell (e.g., the first cell, third cell, etc.). In some embodiments, the second cell (e.g., serving cell, etc.) may indicate a target cell to the UE, such as the first cell, the third cell, or the like. At block 720, the UE executes slimCHO, or the like, toward the first cell using stored TA information and RACH-less handover. Additionally, the UE and/or network may store all of the CHO-configurations for the first cell, second cell, and third cell. Moreover, the UE may store TA information for second cell (e.g., the previous serving cell). In some embodiments, the UE may reuse the first BM reporting configuration reported to the first cell. In some embodiments, the UE may use the second BM reporting configuration reported to the second cell or another BM reporting configuration reported to another serving cell. In some embodiments, switching between cells via handovers may be determined based on the BM reporting configurations (e.g., BM reporting information or the like).

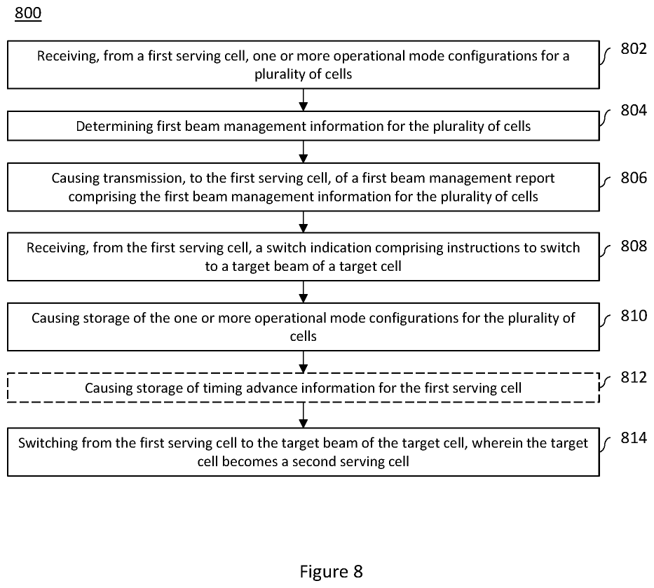

FIG. 8 illustrates a flowchart of the operations of an example method 800 performed by an example apparatus 200 which, in one embodiment, may be embodied by one or more computing devices (e.g., as described above with respect to FIG. 4), such as a user equipment (e.g., UE 102, a smart phone, laptop computer, etc.), which may, in turn, include a computer program product comprising a non-transitory computer-readable medium storing computer program code to be executed by at least processor 202. The user equipment may be in communication with at least a wireless network, such as communications network 100, via one or more of a cell, a beam, a base station, or the like. As shown in block 802, apparatus 200 of this example embodiment includes means, such as the processor 202, the memory 204, the communication interface 206 and/or the like, for receiving, from a first serving cell, one or more operational mode configurations for a plurality of cells.

As shown in block 804, apparatus 200 (e.g., a smart phone, laptop or tablet computer, etc.) is further configured with means, such as the processor 202, the communication interface 206 or the like, for determining first beam management information for the plurality of cells. In response to determining the first beam management information, apparatus 200 of this example embodiment may further include means, such as the processor 202, the memory 204, the communication interface 206 or the like, for causing transmission, to the first serving cell, of a first beam management report comprising the first beam management information for the plurality of cells, see block 806.

Moreover, apparatus 200 of this example embodiment may further include means, such as the processor 202, the memory 204, the communication interface 206 or the like, for receiving, from the first serving cell, a switch indication comprising instructions to switch to a target beam of a target cell, see block 808. Upon receipt of the switch indication, or similar indications (e.g., an externally received and/or internally generated indication, a predefined threshold associated with a measurable value, elapse of a predefined time interval, or the like), the apparatus 200 is configured with means for causing storage of the one or more operational mode configurations for the plurality of cells, see block 810. In some embodiments, the apparatus 200 may be further configured with means for causing storage of timing advance information for the first serving cell (e.g., cell 508A as described above with respect to FIG. 6), see block 812. At block 814, the apparatus 200, for example based on at least the first beam management information and/or the switch indication, is configured for switching from the first serving cell to the target beam of the target cell, wherein the target cell becomes a second serving cell.

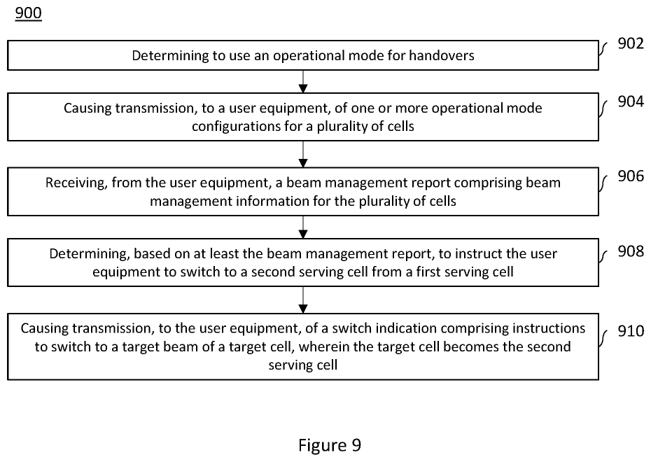

FIG. 9 illustrates a flowchart of the operations of an example method 900 performed by an example apparatus 200 which, in one embodiment, may be embodied by one or more computing devices (e.g., as described above with respect to FIG. 4), such as a radio access network (e.g., RAN 104, etc.) or portion thereof (e.g., base station 502, base station 504, base station 506, cell(s) 508A-C, and/or the like). The one or more computing devices may, in turn, include a computer program product comprising a non-transitory computer-readable medium storing computer program code to be executed by at least processor 202. The one or more computing devices may be in communication with at least a wireless network, such as communications network 100, via one or more interfaces (e.g., N2 interface, or the like). The one or more computing devices may be in communication with at least one user equipment, such as UE 102 or the like, via one or more interfaces (e.g., N2 interface, or the like). As shown in block 902, apparatus 200 of this example embodiment includes means, such as the processor 202, the memory 204, the communication interface 206 and/or the like, for determining to use an operational mode for handovers.

As shown in block 904, apparatus 200 (e.g., base station 502 serving cell 508A and at least beam 512 and/or 513, etc.) is further configured with means, such as the processor 202, the communication interface 206 or the like, for causing transmission, to a user equipment, of one or more operational mode configurations for a plurality of cells. Apparatus 200 of this example embodiment may further include means, such as the processor 202, the memory 204, the communication interface 206 or the like, for receiving, from the user equipment, a beam management report comprising beam management information for the plurality of cells, see block 906. In some embodiments, the apparatus 200 may be further configured with means for causing transmission, to the plurality of cells, of information about the operational mode for handovers.

Moreover, apparatus 200 of this example embodiment may further include means, such as the processor 202, the memory 204, the communication interface 206 or the like, for determining, based on at least the beam management report, to instruct the user equipment to switch to a second serving cell from a first serving cell, see block 908. Upon determining to instruct the user equipment to switch serving cells, or based on one or more similar indications (e.g., an externally received and/or internally generated indication, a predefined threshold associated with a measurable value, elapse of a predefined time interval, or the like), the apparatus 200 is configured with means for causing transmission, to the user equipment, of a switch indication comprising instructions to switch to a target beam of a target cell, wherein the target cell becomes the second serving cell, see block 910. In some embodiments, the apparatus 200 may be further configured with means for causing storage of the one or more operational mode configurations for the plurality of cells.

It should be appreciated, in light of the present disclosure, that example embodiments described herein provide for a plurality of improvements over conventional systems. Example embodiments of the present disclosure provide for frequent switching between a plurality of cells with much less overhead than conventional systems. For example, handover preparation may only be done once and then the UE can toggle between the configured cells with slimCHO/MAC CE procedures. Example embodiments of the present disclosure provide for more robustness due to the usage of FCSCHO, and due to less signaling that allows for earlier and/or more aggressive switching and faster correction of previous decisions (e.g., previous target cell selection and switching). Moreover, storing TA information and using the stored TA information for RACH-less execution reduces handover interruption times. Furthermore, through MAC CE triggering of the FCSCHO, the network can determine with a higher level of certainty the moment in time when the UE changed from a serving cell to another serving cell (e.g., in contrast to the uncertainty associated with conventional systems) and, thus, the network may be configured to initiate more efficient data packet forwarding.

Example embodiments of the present disclosure (e.g., such as those described with respect to FIGS. 5-9) provide for serving cell handovers for use with one or more of Industrial Internet of Things (HOT), Video, Imaging, and Audio for Professional Applications (VIAPA), or similar environments and/or system architectures. For example, embodiments of the present disclosure may be associated with one or more VIAPA applications, such as audio transport, audio transport presentation, video, imaging and/or video for medical applications, or the like (e.g., motion control, mobile robots, etc.) that may be used in association with one or more of a mobile or stationary UE. Moreover, embodiments of the present disclosure may be associated with one or more IIoT applications, such as motion controls, mobile robots, mobile control panels, mobile operation panels, augmented/virtual reality in human-machine interfaces, cooperative carrying, wired to wireless link replacements, closed-loop controls, or the like that may be used in association with one or more of a mobile or stationary UE. It should be appreciated, in light of the present disclosure, that the embodiments described herein may be scaled to cover a plurality of service/coverage areas (e.g., indoors and/or outdoors, 50×10×10 cubic meters, 1 square kilometer, etc.), a plurality of latency times (e.g., 0.5 ms, 500 ms, 30 second (s), 1 minute (min), etc.), a plurality of network architectures (e.g., as described above with respect to the figures, single-cell architectures, multi-cell architectures, etc.), or the like.

As described above, the referenced flowcharts of methods that can be carried out by an apparatus according to related computer program products comprising computer program code. It will be understood that each block of the flowcharts, and combinations of blocks in the flowcharts, can be implemented by various means, such as hardware, firmware, processor, circuitry, and/or other devices associated with execution of software including one or more computer program instructions. For example, one or more of the procedures described above can be embodied by computer program instructions. In this regard, the computer program instructions which embody the procedures described above can be stored by a memory device, e.g., 204, of an apparatus, e.g., 200, employing an embodiment of the present invention and executed by processor, e.g., 202, of the apparatus. As will be appreciated, any such computer program instructions can be loaded onto a computer or other programmable apparatus (e.g., hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture, the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above. In other embodiments, the computer program instructions, such as the computer-readable program code portions, need not be stored or otherwise embodied by a non-transitory computer-readable storage medium, but can, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations, methods, steps, processes, or the like, above can be modified or further amplified. Furthermore, in some embodiments, additional optional operations, methods, steps, processes, or the like, can be included. Modifications, additions, subtractions, inversions, correlations, proportional relationships, disproportional relationships, attenuation and/or amplifications to the operations above can be performed in any order and in any combination. It will also be appreciated that in instances where particular operations, methods, processes, or the like, required particular hardware such hardware may be considered as part of apparatus 200 for any such embodiment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

1. A method comprising:
receiving, from a first serving cell, one or more operational mode configurations for a plurality of cells;
determining first beam management information for the plurality of cells;
causing transmission, to the first serving cell, of a first beam management report comprising the first beam management information for the plurality of cells;
receiving, from the first serving cell, a switch indication comprising instructions to switch to a target beam of a target cell;
causing storage of the one or more operational mode configurations for the plurality of cells; and
switching from the first serving cell to the target beam of the target cell, wherein the target cell becomes a second serving cell.

2. The method according to claim 1, further comprising:
causing storage of timing advance information for the first serving cell;
determining second beam management information for the plurality of cells;
causing transmission, to the second serving cell, of a second beam management report comprising the second beam management information for the plurality of cells;
retrieving the one or more operational mode configurations and the timing advance information; and
switching, based on at least the timing advance information, from the second serving cell to the first serving cell.

3. The method according to claim 2, wherein switching from the first serving cell to the second serving cell comprises a random access channel-less handover, and wherein the stored timing advance information is used for switching from the second serving cell to the first serving cell.

4. The method according to claim 2, wherein the one or more operational mode configurations comprises one or more of a fast cell selection conditional handover configuration for each cell of the plurality of cells, the first beam management information, or the second beam management information.

5. The method according to claim 2, wherein one or more of the first beam management information or the second beam management information are generated based on reference signals transmitted by the plurality of cells, wherein the reference signals comprise synchronization signal block resource mapping.

6. The method according to claim 2, wherein one or more of the first beam management report or the second beam management report comprise one or more of intracell or intercell beam management reporting associated with one or more cells of the plurality of cells.

7. The method according to claim 2, wherein one or more of a user equipment, a network, a radio access network, a base station, or a cell store one or more of the one or more operational mode configurations, the first beam management information, the second beam management information, or the timing advance information for at least a respective cell of the plurality of cells.

8. The method according to claim 1, wherein the plurality of cells comprises one or more of a neighboring cell of the first serving cell, a neighboring cell of the second serving cell, the first serving cell, or the second serving cell.

9. The method according to claim 1, wherein the switch indication comprises a medium access control element.

10. The method according to claim 1, wherein the switching to the target beam of the target cell is dynamically caused by a trigger condition configured by the first serving cell or the second serving cell.

11. The method according to claim 1, wherein the target cell is associated with a plurality of target beams.

12. An apparatus comprising:
at least one processor; and
at least one memory including computer program code,
the at least one memory and the computer program code configured to, with the at least one processor, cause the apparatus at least to:
receive, from a first serving cell, one or more operational mode configurations for a plurality of cells;
determine first beam management information for the plurality of cells;
cause transmission, to the first serving cell, of a first beam management report comprising the first beam management information for the plurality of cells;
receive, from the first serving cell, a switch indication comprising instructions to switch to a target beam of a target cell;
cause storage of the one or more operational mode configurations for the plurality of cells; and
switch from the first serving cell to the target beam of the target cell, wherein the target cell becomes a second serving cell.

13. The apparatus according to claim 12, wherein the at least one memory and the computer program code are further configured to, with the at least one processor, cause the apparatus to:
cause storage of timing advance information for the first serving cell;
determine second beam management information for the plurality of cells;
cause transmission, to the second serving cell, of a second beam management report comprising the second beam management information for the plurality of cells;
retrieve the one or more operational mode configurations and the timing advance information; and
switch, based on at least the timing advance information, from the second serving cell to the first serving cell.

14. The apparatus according to claim 13, wherein switching from the first serving cell to the second serving cell comprises a random access channel-less handover, and wherein the stored timing advance information is used for switching from the second serving cell to the first serving cell.

15. The apparatus according to claim 13, wherein the one or more operational mode configurations comprises one or more of a fast cell selection conditional handover configuration for each cell of the plurality of cells, the first beam management information, or the second beam management information.

16. The apparatus according to claim 13, wherein one or more of the first beam management information or the second beam management information are generated based on reference signals transmitted by the plurality of cells, wherein the reference signals comprise synchronization signal block resource mapping.

17. The apparatus according to claim 13, wherein one or more of the first beam management report or the second beam management report comprise one or more of intracell or intercell beam management reporting associated with one or more cells of the plurality of cells.

18. The apparatus according to claim 13, wherein one or more of a user equipment, a network, a radio access network, a base station, or a cell store one or more of the one or more operational mode configurations, the first beam management information, the second beam management information, or the timing advance information for at least a respective cell of the plurality of cells.

19. The apparatus according to claim 12, wherein the plurality of cells comprises one or more of a neighboring cell of the first serving cell, a neighboring cell of the second serving cell, the first serving cell, or the second serving cell.

20. The apparatus according to claim 12, wherein the switch indication comprises a medium access control element.

21.-36. (canceled)
